(19) United States
(12) Patent Application Publication
(10) Pub. No.: US 2012/0262500 A1
(43) Pub. Date: Oct. 18, 2012

(54) OPTICAL FILTER, DISPLAY CELL, AND DISPLAY

(75) Inventors: Tazuko Kitazawa, Osaka (JP); Yuji Yashiro, Osaka (JP); Noboru Iwata, Osaka (JP)

(73) Assignee: Sharp Kabushiki Kaisha, Osaka (JP)

(21) Appl. No.: 13/445,234

(22) Filed: Apr. 12, 2012

(30) Foreign Application Priority Data
Apr. 12, 2011 (JP) 2011-088556
Oct. 17, 2011 (JP) 2011-227783
Oct. 17, 2011 (JP) 2011-227786

(51) Int. Cl. G09G 5/10; G02B 5/30

(52) U.S. Cl. 345/690; 359/491.01

(57) ABSTRACT

Provided are a filter unit 4 in which a plurality of metallic particles 42 having two or more anisotropic axes are disposed with uniform orientations on a surface or interior part of a transparent dielectric medium 41 transmitting visible light, and direction adjusting means 3 for changing, in a relative manner, the polarization of incident light, which incident on the filter unit with linear polarization, and the orientation of the anisotropic axes of the metallic particles 42.

This application is based on Japanese Patent Application 2011-88556 filed on Apr. 12, 2011; Japanese Patent Application 2011-227783 filed on Oct. 17, 2011; and Japanese Patent Application 2011-227786, filed on Oct. 17, 2011.

### BACKGROUND OF THE INVENTION

1. Field of the Invention

The present invention relates to an optical filter, a display cell, and a display.

2. Description of Related Art

A phenomenon is known in metallic particles wherein specific wavelengths of incident light are absorbed due to resonance between the incident light and electrons in the metallic particles (surface plasmon resonance). Advantage has long been taken of this phenomenon to mix specific metallic particles with glass to create stained glass. Recently, applications to optical filters and paints have also been made.

The surface plasmon resonance spectrum of the metallic particles depends upon the type of metal constituting the metallic particles, the size of the particles, their shape, and the surrounding index of refraction. As an optical filter using these characteristics, Japanese Patent 4348720 discloses an optical filter in which nanorod-shaped metallic particles are formed, the metallic nanorods are mixed with and dispersed in a resin to create a film, the lengths of the minor and major axes of the nanorods are adjusted, and light with wavelengths falling in a range from visible light to near infrared light are selectively absorbed.

Unexamined Japanese Patent Application Publication 2005-126310 discloses an optical filter in which a noble metal is formed into nanorods, the properties arising from the minor and major axes of the nanorods are manifested, and near infrared radiation shielding and design properties can be imparted to glass.

For example, in an LCD panel capable of displaying color, each pixel is configured so as to transmit red light (R), green light (G), and blue light (B). The optical filter described above is often used as a member transmitting these different types of light. Specifically, in a color filter described in Japanese Patent 4348720 and a color filter described in Unexamined Japanese Patent Application Publication 2005-126310, a color filter transmitting each of R, G, and B light is formed, a color filter for each color is laid over a pixel as appropriate, and intensity of light entering the each color filter is adjusted to determine the color of the pixel.

However, the color filter according to Japanese Patent 4348720 is a color filter having an absorption wavelength based on the long axis of rod-shaped particles, and that of Unexamined Japanese Patent Application Publication 2005-126310 is a color filter having an absorption wavelength based on the minor and major axes of nanorods, making it impossible to adjust or change the absorption, transmission, or scattering wavelengths of the color filter once it has been manufactured, and a plurality of types of color filter having different absorption, transmission, and scattering wavelengths are necessary in advance.

Also, when a color filter for each of RGB is used, the configuration displays one color out of RGB, i.e., blocks light of other colors, which can lead to poor light use efficiency.

### SUMMARY OF THE INVENTION

The present invention was contrived in light of these points, and has as an object thereof the provision of an optical filter using metallic particles whose absorption, transmission, and scattering wavelengths can be adjusted. Another object is to provide a display cell using such an optical filter and a display having the display cell.

An optical filter according to one embodiment of the present invention provides an optical filter having a filter unit in which a plurality of metallic particles having two or more anisotropic axes are disposed with uniform orientations on a surface or interior part of a transparent dielectric medium transmitting visible light, and direction adjusting means for changing, in a relative manner, the polarization of incident light, which incident on the filter unit with linear polarization, and the orientation of the anisotropic axes of the metallic particles.

This configuration allows the surface plasmon resonance wavelength of the metallic particles to be adjusted by means of a simple method of changing, in a relative manner, the incident light polarization and the anisotropic orientation of the metallic particles. Also, the surface plasmon resonance wavelength shifts and the optical filter displays another color when a light polarized between the long axis and the short axis of metallic particles enters the filter. Then, along with the two colors corresponding to the long axis and the short axis, the optical filter is capable of displaying full color using three resonance wavelengths.

It is thereby possible to reduce the number of optical filters, increase the aperture ratio, and improve light use efficiency compared to when using a conventional color filter used in full color displays that extracts light of wavelengths of each of RGB.

In a preferred embodiment of the present invention, the direction adjusting means rotates the incident light polarization of the linearly polarized light in parallel or perpendicularly to the anisotropic axes of the metallic particles. This configuration allows the surface plasmon resonance wavelength of the metallic particles to be adjusted by means of a simple existing liquid crystal element method or the like.

In order to achieve the object described above, an optical filter according to one embodiment of the present invention provides an optical filter characterized in having a filter unit in which a plurality of metallic particles having two or more anisotropic axes are disposed with uniform orientations on a surface or interior part of a transparent dielectric medium transmitting visible light, and direction adjusting means for changing, in a relative manner, the polarization of transmitted light transmitted through the filter unit and the orientation of the anisotropic axes of the metallic particles.

This configuration allows one to adjust the direction in which the surface plasmon resonance excited on the metallic particles being used by means of a simple method of changing, in a relative manner, the transmitted light polarization and the anisotropic orientation of the metallic particles. Alternatively, it is possible to select whether light of surface plasmon resonance wavelength is absorbed or scattered. Also, the surface plasmon resonance wavelength shifts and the optical filter displays another color when a light polarized between the long axis and the short axis of metallic particles enters the filter. Then, along with the two colors corresponding to the long axis and the short axis, one optical filter is capable of displaying from two to four colors.

It is thereby possible to reduce the number of optical filters, increase the aperture ratio, and improve light use efficiency compared to when using a conventional color filter extracting light of wavelengths for each of RGB using in displaying full color. Also, even when using three optical filters as in a conventional method, having four color choices that can be displayed by one filter broadens the range of colors that can be produced.

In a preferred embodiment of the present invention, the direction adjusting means may also rotate the polarization of the transmitted light in parallel or perpendicularly to the anisotropic axes of the metallic particles. This configuration allows the surface plasmon resonance wavelength of the metallic particles to be adjusted by means of a commercially available liquid crystal element or the like.

A preferred embodiment of the present invention may also be configured so that incident light whose polarization is neither parallel nor perpendicular to either of the two anisotropic axes of the metallic particles enters the filter unit. This configuration makes it possible to select whether light of the surface plasmon resonance wavelength is absorbed or scattered, allowing for more colors to be displayed using one optical filter and broadening the range of colors that can be produced,

A preferred embodiment of the present invention may also have second direction adjusting means for changing, in a relative manner, the incident light polarization of light entering the filter unit and the orientation of the anisotropic axes of the metallic particles. This configuration makes it possible to select at a high light use efficiency whether light of the surface plasmon resonance wavelength is absorbed or scattered, allowing for more colors to be displayed using one optical filter and broadening the range of colors that can be produced.

In a preferred embodiment of the present invention, the transparent dielectric medium may rotatably support the plurality of metallic particles, and either one of the direction adjusting means and the second direction adjusting means may rotate the plurality of metallic particles in an orientation-aligned state either on the surface or in the interior of the transparent dielectric medium. In this configuration, means for rotating the polarization is not necessary, allowing reductions in light transmission to be suppressed. Energy consumption of an optical filter of the present invention can be thereby reduced.

In a preferred embodiment of the present invention, the transparent dielectric medium rotatably support the plurality of metallic particles, and the direction adjusting means may rotate the plurality of metallic particles with identical orientations either on the surface or in the interior of the transparent dielectric medium. In this configuration, means for rotating the polarization is not necessary, allowing reductions in light transmission to be suppressed. Energy consumption of an optical filter of the present invention can be thereby reduced.

In a preferred embodiment of the present invention, the plurality of metallic particles have three anisotropic axes, and the direction adjusting means rotates the plurality of metallic particles either on the surface or in the interior of the transparent dielectric medium in a direction perpendicular to the surface of the transparent dielectric medium. In this configuration, the metallic particles have three surface plasmon resonance wavelengths, yielding an optical filter wherein one optical filter is capable of displaying full color. It is thereby possible to reduce the number of optical filters, thus improving light use efficiency.

In a preferred embodiment of the present invention, the plurality of metallic particles are arrayed in the light irradiation direction, and the array interval is five or more times the irradiation direction length of the metallic particles. This configuration allows for peak shift caused by interaction between the metallic particles to be prevented, allowing the metallic particles to be designed with only the absorption peak of one metallic particle in mind.

The present invention provides a display cell having one of the above optical filters, a light source for emitting visible light, and a light intensity adjuster for adjusting the intensity of the light entering the optical filter.

This configuration allows for a transmission display capable of producing two colors and a mixture thereof using one optical filter. As a result, the number of filters needed to display full color can be two or less, allowing for a high aperture ratio and improved light use efficiency.

Because the surface plasmon resonance wavelength shifts when a polarization between the long axis and the short axis enters the filter along with the two colors corresponding to the long axis and the short axis, it is possible to display full color using three resonance wavelengths. Also, when the metallic particles are rotated in three dimensions, one optical filter has three surface plasmon resonance wavelengths, enabling one optical filter to display full color. It is thereby possible to reduce the number of optical filters, thus improving light use efficiency.

A preferred embodiment of the present invention has two optical filters, and both of the two optical filters have a filter unit in which the surface plasmon resonance wavelength of the metallic particles is a complementary color of red.

In this configuration, red, to which the human eye has low sensitivity, is produced using two optical filters, and the aperture ratio for red increases, meaning that incident light intensity need not be increased, and energy consumption of an optical filter of the present invention can be reduced.

A preferred embodiment of the present invention has two optical filters, of which one optical filter has a filter unit where the surface plasmon resonance wavelengths of the metallic particles are complementary colors of red and blue, and the unit of the other filter where the surface plasmon resonance wavelengths of the metallic particles are complementary colors of green and yellow. This configuration allows four colors to be produced using two optical filters, allowing for highly vivid color representation and bright white production.

The present invention provides a display cell having one of the above optical filters, an anti-reflective layer for reducing visible light reflectivity, and a light intensity adjuster for adjusting the intensity of the light entering the optical filter.

This configuration uses the optical filter according to the present invention, allowing for a reflective display cell capable of producing two colors and a mixture thereof using one optical filter.

A preferred embodiment of the present invention has two optical filters, and both of the two optical filters have a filter unit in which the surface plasmon resonance wavelength of the metallic particles is red.

In this configuration, red, to which the human eye has low sensitivity, is produced using two optical filters, and the aperture ratio for red increases, meaning that incident light intensity need not be increased, and energy consumption of an optical filter of the present invention can be reduced.

The present invention provides a display cell having one of the above optical filters, a scattering layer for scattering visible light, and a light intensity adjuster for adjusting the intensity of the light entering the optical filter.

This configuration uses the optical filter according to the present invention, allowing for a scattering display cell capable of producing two colors and a mixture thereof using one optical filter.

A preferred embodiment of the present invention has two optical filters, and one of the two optical filters has a filter unit in which the surface plasmon resonance wavelength of the metallic particles is outside the visible spectrum. This configuration creates a surface plasmon resonance wavelength outside the visible spectrum, allowing white to be produced, thereby enabling full color display.

The present invention provides a display having a plurality of one of the display cells described above, wherein the plurality of display cells are arrayed in two dimensions.

In a preferred embodiment of the present invention, the display has a data input unit into which image data is inputted; a direction adjuster driving circuit for controlling the direction adjusting means; a light intensity adjuster driving circuit for controlling the light intensity adjuster; and an operation unit for determining the color and intensity displayed by each of the display cells on the basis of the image data, and issuing an instruction to the direction adjuster driving circuit and the light intensity adjuster driving circuit so as to drive the direction adjusting means and the light intensity adjuster of each of the display cells based on the color and intensity.

### BRIEF DESCRIPTION OF THE DRAWINGS

FIG. 1 is a schematic perspective view of one example of an optical filter according to the present invention.

FIG. 2A is an illustration of the relationship between the peak wavelength of an absorption spectrum and an incident light polarization with respect to silver metallic particles.

FIG. 2B is an illustration of the relationship between the peak wavelength of an absorption spectrum and an incident light polarization with respect to silver metallic particles.

FIG. 2C is an illustration of the relationship between the peak wavelength of an absorption spectrum and an incident light polarization with respect to silver metallic particles.

FIG. 3 is an illustration of incident light polarization with respect to metallic particles arrayed on a flat surface and electrical field intensity immediately after metallic particles.

FIG. 4A is an illustration of the relationship between number of layers and far-field electrical field intensity when two-dimensionally arrayed silver metallic particles are disposed in layers in the light irradiation direction.

FIG. 4B is an illustration of the relationship between distance between layers and far-field electrical field intensity when two-dimensionally arrayed silver metallic particles are disposed in layers in the light irradiation direction.

FIG. 5 is an outline of another example of a display according to the present invention.

FIG. 6 is an illustration of the polarization dependence of an electrical field intensity immediately after metallic particles arrayed on a flat surface.

FIG. 7 is an illustration of the relationship between a transmission spectrum and a transmitted light polarization with respect to silver metallic particles.

FIG. 8 is a schematic perspective view of another example of an optical filter according to the present invention.

FIG. 9 is an outline of one example of a display according to the present invention.

FIG. 10 is an outline of another example of a display according to the present invention.

FIG. 11 is an outline of yet another example of a display according to the present invention.

FIG. 12 is an outline of yet another example of a display according to the present invention.

### DETAILED DESCRIPTION OF PREFERRED EMBODIMENTS

Hereafter follows a description of an embodiment of the present invention with reference to the drawings. First, a configuration of an optical filter according to the present invention and a method of manufacturing the same will be described.

### First embodiment

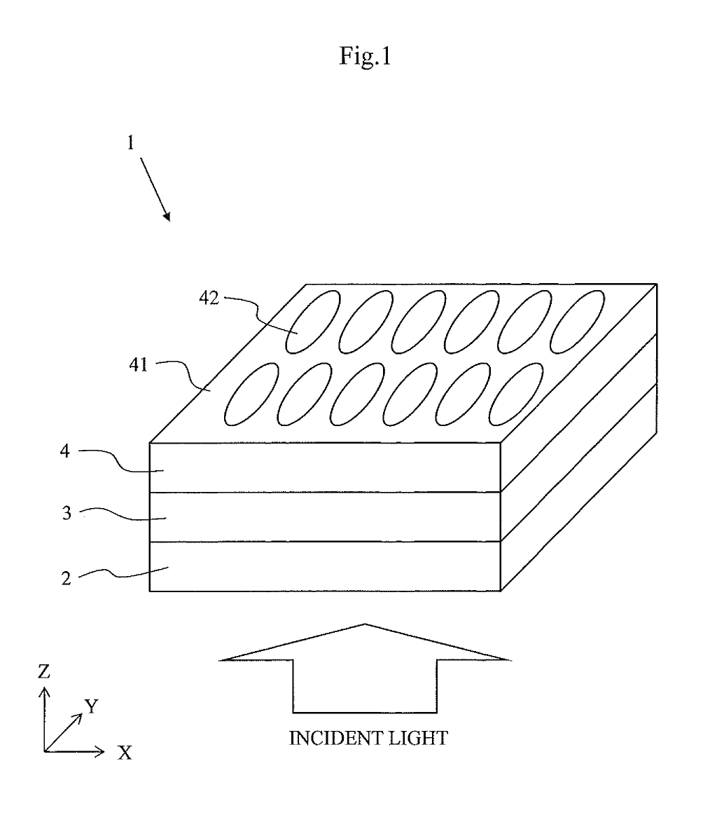

FIG. 1 is a schematic outline perspective view of an optical filter according to the present invention. In the following description, as shown in FIG. 1 and elsewhere, the horizontal direction with respect to the surface of the drawing is the X direction, the perpendicular direction with respect to the surface of the drawing is the Y direction, and the vertical direction with respect to the surface of the drawing is the Z direction, unless otherwise indicated.

As shown in FIG. 1, an optical filter 1 is a filter transmitting light of a specific wavelength region (absorbing light of a specific wavelength region) of incident light. The optical filter 1 has a polarizing plate 2, a directional adjuster 3 (direction adjusting means), and a filter unit 4 disposed in the order the polarizing plate 2, the directional adjuster 3, and the filter unit 4 in the direction of light incidence (light source direction).

The polarizing plate 2 is adapted for extracting only specific linearly polarized light from the incident light, and has a configuration identical to that of conventionally well-known polarizing plates. When the incident light is only linearly polarized light, the polarizing plate 2 may be omitted, but optical filter 1 uses a polarizing plate 2. Incident light penetrates the polarizing plate 2 to become linearly polarized light having the same polarization, and enters the directional adjuster 3. In the optical filter 1 shown in FIG. 1, the polarizing plate 2 extracts light whose polarization is the X direction (X-polarized light).

The directional adjuster 3 changes relatively the polarization of the linearly polarized light transmitted by the polarizing plate 2. The directional adjuster 3 is an optical element having liquid crystal, with a gap between a pair of flat electrode substrates disposed in parallel with a pre-determined spacing therebetween being filled with liquid crystal. The directional adjuster 3 is disposed between the polarizing plate 2 and the filter unit 4. The directional adjuster 3 is capable of rotating incident linearly polarized light when an external electronic drive signal is received (voltage applied to the liquid crystal). The electrodes sandwiching the liquid crystal of the directional adjuster 3 are preferably transparent, with examples thereof including transparent electrodes using indium tin oxide (ITO) or indium zinc oxide (IZO).

The directional adjuster 3 is not limited to using liquid crystal, and may, for example, use a Faraday element or a half-wave plate. A Faraday element is an element for adjusting the polarization of transmitted light using a magnetic field, and, as with liquid crystal, can rotate incident linearly polarized light by means of an external electronic operation signal inputted to the electrode. When a half-wave plate is used, incident linearly polarized light can be rotated manually by a user or automatically by an external signal.

The filter unit 4 has a transparent dielectric medium 41 and metallic particles 42. The transparent dielectric medium 41 is a substrate for dispersing the metallic particles 42, and is transparent for a specific type of light (in this case, visible light). The transparent dielectric medium 41 may be a glass substrate or an organic film such as a polyethylene terephthalate (PET) film.

When liquid crystal is used as the directional adjuster 3, the transparent dielectric medium 41 of the filter unit 4 may double as one electrode of the directional adjuster 3. The directional adjuster 3 and the filter unit 4 having such a configuration may be manufactured by, for example, the following method. After metallic particles 42 are dispersed on one surface of a piece of glass constituting the transparent dielectric medium 41 and an ITO layer is formed on the other surface as a transparent electrode by means of a high-frequency sputtering method, an electrode pattern is formed using a photolithographic method. Afterwards, an orientation layer is applied and rubbed, the other electrode substrate is disposed in parallel to the transparent dielectric medium 41, and the gap between the other electrode substrate and the transparent dielectric medium 41 is filled with liquid crystal and sealed. Using the above method, an integrated the directional adjuster 3 and the filter unit 4 can be manufactured.

The metallic particles 42 are of a metal causing surface plasmon resonance, with commonly used examples including gold, silver, copper, aluminum, platinum, palladium, and the like. As shown in FIG. 1, the metallic particles 42 have an elliptical shape in which the length of the Y direction is greater than the length of the X direction. The lengths of the X direction, Y direction, and Z direction are from a few nanometers to approximately 100 nanometers. As will be described in detail below, the length of these metallic particles 42, their relative proportions (hereafter referred to as “aspect ratio”), and the incident light polarization determine the wavelength of light transmitted by the filter unit 4 that is absorbed (scattered). The metallic particles 42 shown in FIG. 1 have rounded corners like an ellipsoid, but the particles are not limited to this, and may have unrounded corners like, for example, a rectangular parallelopiped, cylinder, or elliptic cylinder. The metallic particles should just be formed so that the length of two different directions at least may differ.

As shown in FIG. 1, the metallic particles 42 are scattered on a surface of the transparent dielectric medium 41. The metallic particles 42 all have the same shape and size, and are disposed identically orientated and equally spaced. The metallic particles 42 may be scattered within the transparent dielectric medium 41, and the spacing therebetween need not be equal as long as the orientation is the same. Examples of methods of arraying the metallic particles 42 on the transparent dielectric medium 41 include a fluid method, the Langmuir-Blodgett method, bubble inflation, arraying using an electric field, and a roll-to-roll method.

In the filter unit 4 shown in FIG. 1, the metallic particles 42 are arrayed in two dimensions (X direction and Y direction), but they may also be arrayed in three dimensions. It is better for there to be a greater amount of metallic particles 42 (in terms of amount per unit of area or volume), but when metallic particles 42 contact each other or are too close together, different optical characteristics from those of a single particle may be obtained. It is known that, in order to prevent changes in optical characteristics, the distance between metallic particles 42 is preferably 5 nm or greater.

The filter unit 4 is manufactured in the following way. A metallic layer is formed on the surface of a solid transparent dielectric medium 41 such as glass, plastic, or a polymer, after which the part that will become the metallic particles 42 is masked, and the peripheral parts are extracted by a photolithographic process or the like. When a light-curing resin is used as the transparent dielectric medium 41, the light-curing resin may be cured after arranging the metallic particles 42 in a desired orientation, and the metallic particles 42 fixed in place. The method of manufacturing the filter unit is not limited to this.

Next, a mechanism for absorbing (scattering) a specific wavelength using the filter unit 4 will be described with reference to specific simulation results. The filter unit 4 uses surface plasmon resonance occurring when light irradiates the metallic particles 42, and absorbs (scatters) a specific wavelength (may be referred to as “surface plasmon resonance wavelength” or simply as “resonance wavelength”).

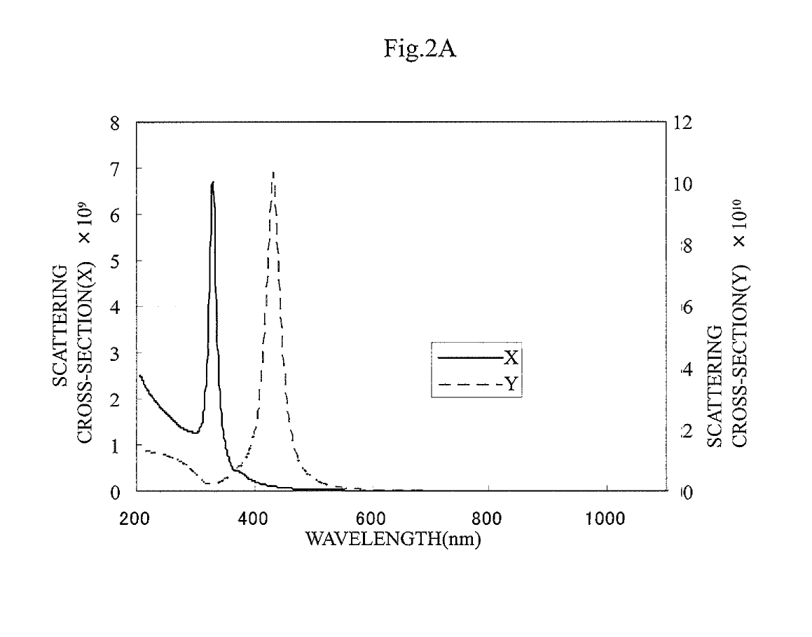

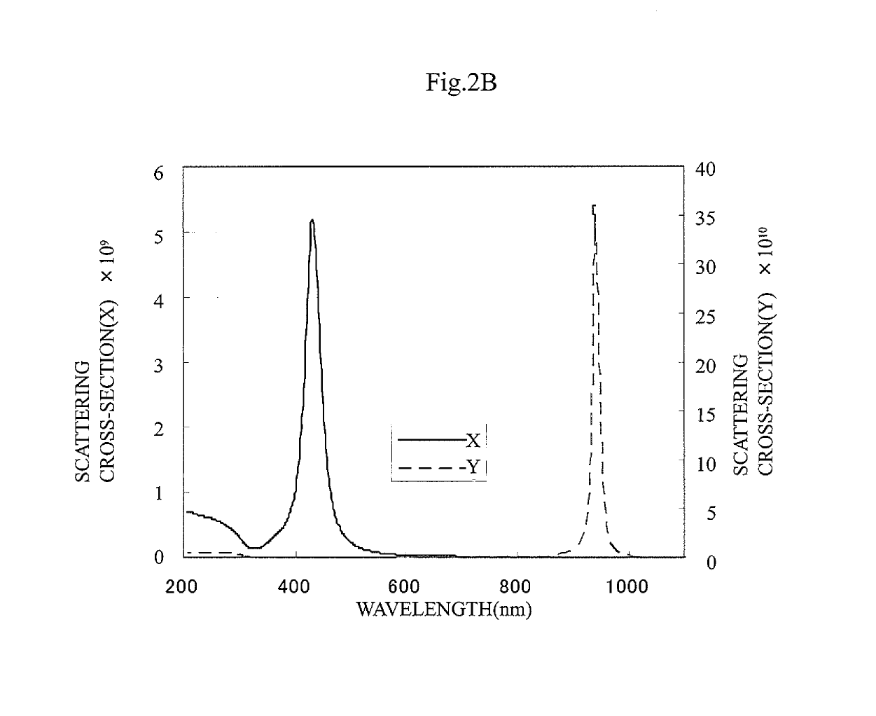

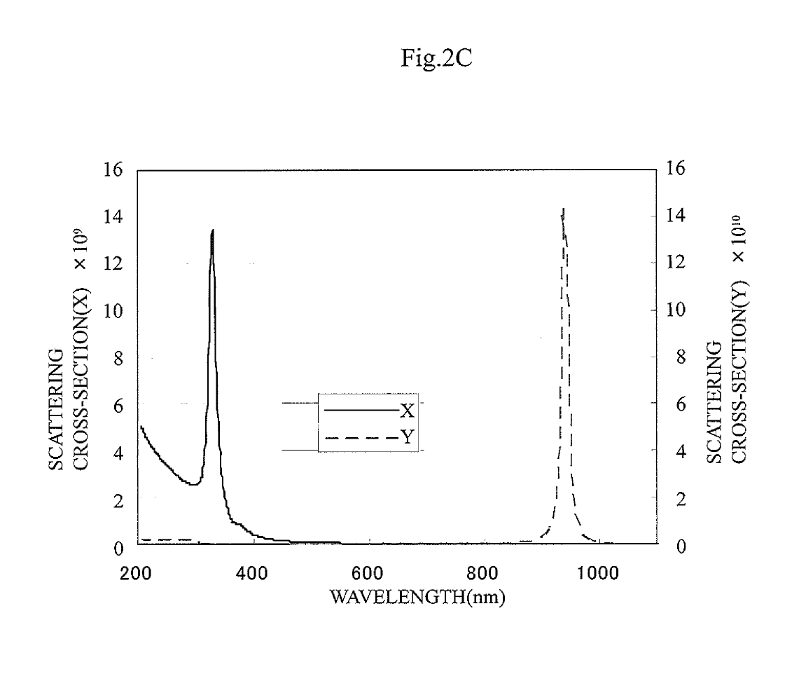

In order to describe the surface plasmon resonance wavelength of the filter unit 4, a wavelength absorbed by surface plasmon resonance when light irradiates metallic particles present in the air will first be described with reference to the drawings. FIGS. 2A through 2C show near-field components of a scattering cross-section when light of a predetermined polarization irradiates silver particles. The results of FIGS. 2A through 2C were obtained by performing a simulation of light irradiating silver particles of different shape.

The relationship between the shape of the silver particles used in the simulation of FIGS. 2A through 2C and the light is as follows. FIG. 2A shows results for when the polarization of light proceeding in the Z direction is the X direction and the Y direction when silver particles 5 nm in length in the X direction, 20 nm in length in the Y direction, and 100 nm in length in the Z direction are present in the air. FIG. 2B shows results for when the polarization of light proceeding in the Z direction is the X direction and the Y direction when silver particles 20 nm in length in the X direction, 100 nm in length in the Y direction, and 5 nm in length in the Z direction are present in the air. FIG. 2C shows results for when the polarization of light proceeding in the Z direction is the X direction and the Y direction when silver particles 5 nm in length in the X direction, 100 nm in length in the Y direction, and 20 nm in length in the Z direction are present in the air.

That is, FIGS. 2A through 2C show calculated results of Rayleigh scattering due to the silver particles when silver particles of the same shape (aspect ratio) and size and the polarization rotated relatively to each other. The near-field components of the scattering cross-section correspond to the generation of near-field light due to light irradiating the metallic particles (silver particles); i.e., the intensity of surface plasmon resonance. Viewed from the far field, the near-field light appears to have been absorbed, so that light lacking this wavelength, i.e., light of a color complementary to the wavelength (surface plasmon resonance wavelength) is seen. It is thus possible to view FIGS. 2A through 2C as absorption spectrums of the metallic particles.

FIGS. 2A through 2C show changes in absorption wavelength depending on the incident direction and polarization of the light with respect to the silver particles. In the configuration shown in FIG. 2A, when X-polarized light irradiates, wavelengths in the vicinity of 330 nm are absorbed; and when Y-polarized light irradiates, wavelengths in the vicinity of 430 nm are absorbed. Likewise, in the configuration shown in FIG. 2B, when X-polarized light irradiates, wavelengths in the vicinity of 430 nm are absorbed; and when Y-polarized light irradiates, wavelengths in the vicinity of 940 nm are absorbed. Furthermore, in the configuration shown in FIG. 2C, when X-polarized light irradiates, wavelengths in the vicinity of 330 nm are absorbed; and when Y-polarized light irradiates, wavelengths in the vicinity of 940 nm are absorbed.

From the foregoing, when the incident light polarization with respect to the metallic particles (in this case, silver particles) is rotated 90°, the absorbed (scattered) wavelength (wavelength region) changes. It goes without saying that the polarization of the light is fixed and the metallic particles are rotated to obtain the same results.

By adjusting the relative angles of the incident light polarization and the anisotropic axes of the metallic particles, the wavelength of absorbed light (wavelength of transmitted light) can be absorbed. For example, in the configuration shown in FIG. 2C, let it be assumed that the incident light has components polarized in both the X-direction and the Y-direction, as for example in the case where the polarization is random, or the light is circularly polarized or 45° polarized. In this case, wavelengths of the X-polarized components of the incident light in the vicinity of 330 nm are absorbed. Likewise, wavelengths of the Y-polarized components of the incident light in the vicinity of 940 nm are absorbed.

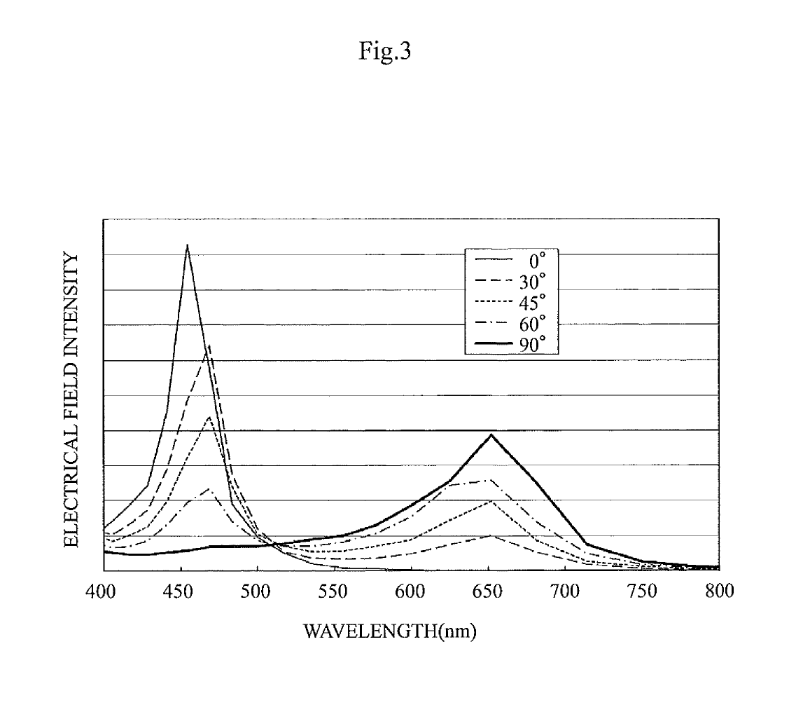

Next, the absorption spectrum resulting when the incident light is changed to the polarization of silver metallic particles arrayed in two dimensions will be described. FIG. 3 is an illustration of incident light polarization with respect to metallic particles arrayed on a flat surface and electrical field intensity immediately after metallic particles. FIG. 3 shows FDTD simulation results, the model of which is as follows. Light with a changed polarization irradiates a two-dimensional array with a 100 nm period in the XY plane of elliptic cylindrical silver metallic particles of size 30 nm in length in the X direction, 60 nm in length in the Y direction, and 10 rim in length in the Z direction. The incident light was a plane wave propagated in the Z direction, with the polarization being taken as 0° when parallel with the X axis. The incident light polarization were 0°, 30°, 45°, 60°, and 90°.

The electrical field intensity is an electrical field intensity enhanced by surface plasmon resonance excited primarily by metallic particles (silver particles). The electrical field intensity manifests almost entirely as near-field light present in the vicinity of the metallic particles, and a part thereof is propagated to the far field as scattered light. Viewed from the far field, the near-field light appears to have been absorbed, so that light lacking this near-field light wavelength, i.e., a color complementary to the surface plasmon resonance wavelength, is seen. In other words, since light of a color complementary to the surface plasmon resonance wavelength is seen in the far field, FIG. 3 can be considered an absorption spectrum.

In FIG. 3, when the polarization is 90° (Y-polarized light), an absorption peak in the vicinity of 650 nm is present; i.e., wavelengths in the vicinity of 650 nm are absorbed. On the other hand, it can be seen that, when the polarization is 0° (X-polarized light), an absorption peak in the vicinity of 455 nm is present; i.e., wavelengths in the vicinity of 455 nm are absorbed. For polarization between these two extremes, the relative intensity of these two absorption peaks is determined by the orientation of the metallic particles and the relative angle of the polarization. It is thereby possible to form a band-pass filter admitting light of wavelength region between these two wavelengths. Thus, the absorption intensity of the absorption peak corresponding to each direction can be changed according to the ratio of polarization components parallel to the two anisotropic axes of the metallic particles; i.e., by adjusting the anisotropicity and polarization of the metallic particles.

In FIG. 3, whereas the absorption wavelength of the short axis at a 0° angle of incidence is in the vicinity of 455 nm, the wavelength shifts to a longer wavelength in the vicinity of 470 nm at 30°, 45°, and 60° angles of incidence. This is because surface plasmon resonance is excited not along the absolute short axis direction. Thus, one may take advantage of this phenomenon to adjust absorption wavelength.

Due to the phenomena described above, the shape and array of the metallic particles of the filter unit and the incident light polarization of the filter unit may be adjusted as appropriate to set the position of the absorption peak of the optical filter at a desired position. In other words, the optical filter can have a desired absorption spectrum.

In the optical filter 1 of the present invention, as described above, the filter unit 4 has a configuration wherein metallic particles 42 are dispersed upon the transparent dielectric medium 41, and the metallic particles 42 are arrayed in two dimensions. Through the polarizing plate 2 and the directional adjuster 3, the optical filter 1 has a configuration allowing the incident light polarization of light entering the filter unit 4. Here follows a description of the operation of an optical filter 1 having such a configuration.

In the optical filter 1 shown in FIG. 1, as described above, the polarization of light transmitted by the polarizing plate 2 is the X direction (X-polarized light). When the directional adjuster 3 does not rotate the polarization, X-polarized incident light irradiates the metallic particles 42. This X-polarized incident light generates surface plasmon resonance corresponding to the size of the X direction of the metallic particles 42, and light of a wavelength region corresponding to the size of the X direction of the metallic particles 42 is absorbed (in FIG. 1, the X direction is the short axis of the metallic particles 42; when the metallic particles used in the simulation of FIG. 3 are used, the wavelength of the absorption peak is 455 nm in the short axis direction).

On the other hand, when the directional adjuster 3 rotates the polarization 90°, Y-polarized incident light irradiates the metallic particles 42. This Y-polarized incident light generates surface plasmon resonance corresponding to the size of the Y direction of the metallic particles 42, and light of a wavelength region corresponding to the size of the Y direction of the metallic particles 42 is absorbed (in FIG. 1, the Y direction is the long axis of the metallic particles 42; when the metallic particles used in the simulation of FIG. 3 are used, the wavelength of the absorption peak is 650 nm in the long axis direction).

When the directional adjuster 3 rotates the polarization between 0° and 90°, incident light having X-polarized components and Y-polarized components irradiates the metallic particles 42. X direction surface plasmon resonance and Y direction surface plasmon resonance of the metallic particles 42 occur according to the ratio of the components; the absorption spectrum is the superposition of these. Additionally, as shown in FIG. 3, the wavelength region of the absorption shifts.

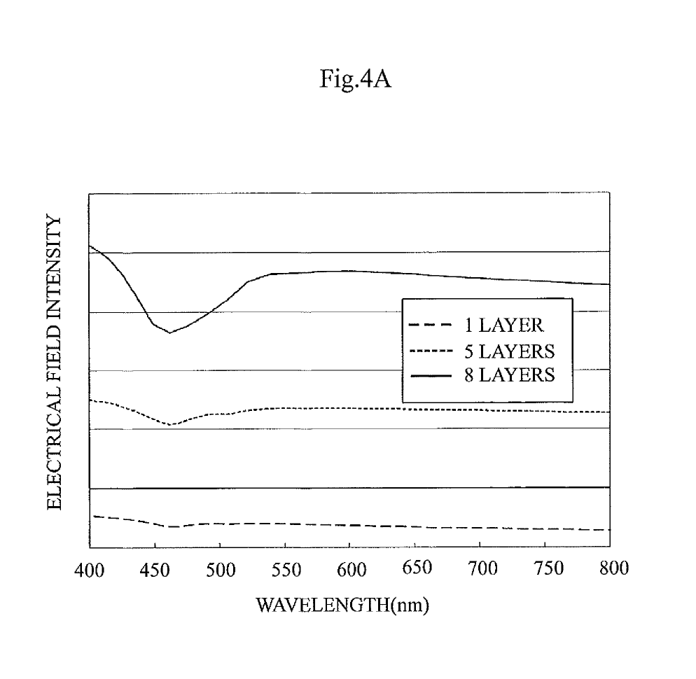

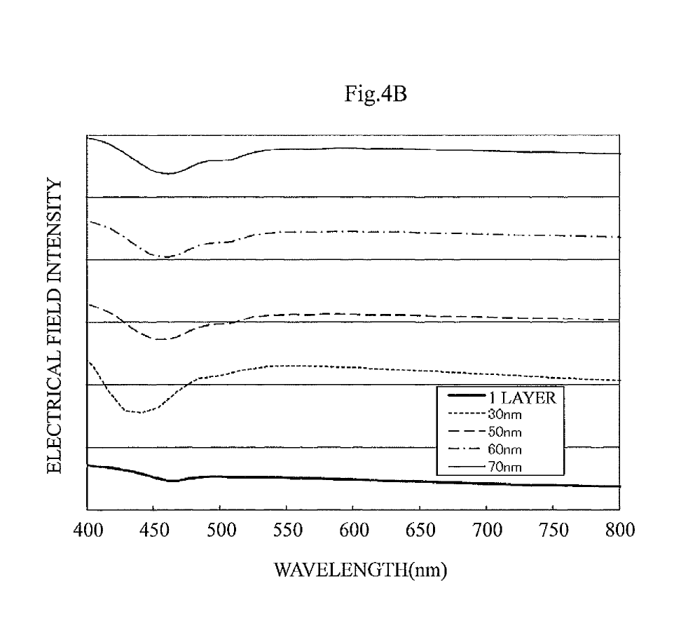

Next, the absorption spectrum viewed in the far field when light irradiates silver metallic particles arrayed in two dimensions will be described. FIG. 4A illustrates the relationship between number of layers and far-field electrical field intensity when two-dimensionally arrayed silver metallic particles are disposed in layers in the light irradiation direction, and FIG. 4B illustrates the relationship between distance between layers and far-field electrical field intensity when two-dimensionally arrayed silver metallic particles are disposed in layers in the light irradiation direction.

In FIG. 4A, the dashed line is an absorption spectrum for the same configuration as in FIG. 3 (one layer), the dotted line is an absorption spectrum for a configuration in which five layers of metallic particles of the same shape as in FIG. 3 are layered at a spacing of 100 nm, and the solid line is an absorption spectrum for a configuration in which eight layers of metallic particles of the same shape as in FIG. 3 are layered at a spacing of 100 nm. The results for the five-layered and eight-layered configurations are shifted along the vertical axis so as not to overlap with the other graphs.

As shown in FIG. 4A, the electrical field intensity in the vicinity of the same wavelength as the absorption peak when the polarization in FIG. 3 is 0° is reduced for the one-layered, five-layered, and eight-layered configurations. In other words, the electrical field intensity immediately after the metallic particles in FIG. 3 is an electrical field intensity enhanced by surface plasmon resonance, and a color complementary to this surface plasmon resonance wavelength is viewed in the far field. Furthermore, even when multiple layers are present, the absorption spectrum thereof corresponds to the absorption spectrum when the polarization is 0° shown in FIG. 3. As shown in FIG. 4A, when the number of layers of metallic particles increases, the amount of light absorbed in the surface plasmon wavelength increases, allowing contrast to be thereby increased.

In FIG, 4B, the bold line is an absorption spectrum for the same configuration as in FIG. 3 (one layer), the dotted line is an absorption spectrum for a configuration in which eight layers of metallic particles of the same shape as in FIG. 3 are layered at a spacing of 30 nm, the long-dashed line is an absorption spectrum for a configuration in which eight layers of metallic particles of the same shape as in FIG. 3 are layered at a spacing of 50 nm, the dotted-dashed line is an absorption spectrum for a configuration in which eight layers of metallic particles of the same shape as in FIG. 3 are layered at a spacing of 60 nm, and the solid line is an absorption spectrum for a configuration in which eight layers of metallic particles of the same shape as in FIG. 3 are layered at a spacing of 70 nm. The results for the eight-layered configurations are shifted along the vertical axis so as not to overlap with the other graphs.

As shown in FIG. 4B, the absorption peak of the 30 nm-spaced configuration has shifted compared to the one-layered configuration. On the other hand, in the configurations where the spacing is 50 nm or greater, the absorption peak is in roughly the same position as in the one-layered configuration. This appears to be because the spacing between layers is narrow, leading to interaction between nearby particles occurring and the absorption peak wavelength shifting. It likewise appears that, by increasing the spacing to 50 nm or more, interaction between nearby articles does not occur (is inhibited), and the absorption peak wavelength returns to almost the same wavelength as in the one-layered configuration.

The spacing sufficient to prevent such interaction from occurring depends on the length of the light irradiation direction of the metallic particles. In other words, the length of the Z direction of the metallic particles in this simulation is 10 nm, and the spacing of 50 nm sufficient to prevent interaction between nearby particles from occurring as described above is approximately five times the length of the Z direction of the metallic particles. Thus, it is preferable that the spacing in the light irradiation direction between aligned metallic particles be five times the length of the irradiation direction of the metallic particles or more. By setting the spacing between nearby metallic particles to spacing such that interaction does not occur, a peak shift caused by interaction between the metallic particles can be prevented, allowing the metallic particles to be designed with only the absorption peak of one metallic particle in mind.

As can be seen from the foregoing, the optical filter 1 of the present invention can be configured to have an absorption peak at two surface plasmon resonance wavelengths corresponding to the long axis and short axis of the metallic particles 42 (in FIG. 1, the Y direction and the X direction). It is thereby possible to appropriately select metallic particles 42 in the optical filter according to the present invention to obtain an optical filter that produces red and blue and an optical filter that produces green (and red), allowing for full color display using two optical filters. As opposed to a conventional optical filter (for example, a color filter with separate RGB coated sections), in which the absorption wavelength is fixed, it is possible to reduce the number of optical filters, improving light use efficiency.

As described above, it is also possible to shift the surface plasmon resonance peak by rotating the incident light polarization. In other words, a configuration having an absorption peak at two surface plasmon resonance wavelengths corresponding to the long axis and short axis of the metallic particles 42 (in FIG. 1, the Y direction and the X direction) and a shifted surface plasmon resonance wavelength is possible. That is, the optical filter 1 of the present invention has three surface plasmon resonance wavelengths. In the optical filter 1, it is possible to produce red, green, and blue by appropriately selecting metallic particles 42, allowing for full color display using one optical filter. In this way, it is possible to reduce the number of optical filters as opposed to a conventional optical filter (for example, a color filter divided into RGB), in which the absorption wavelength is fixed, further improving light use efficiency.

In the case described above, the relationship between the metallic particles 42 and the incident light polarization was adjusted by the directional adjuster 3 rotating the incident light polarization, but the invention is not limited to this. For instance, a configuration in which the directional adjuster rotates the metallic particles 42 is also possible. In such a case, the transparent dielectric medium 41 is preferably a gel or liquid so that the metallic particles 42 can rotate easily. Namely, an identical optical filter can be obtained even when the relationship with the incident light polarization is adjusted by rotating the metallic particles 42.

A technique of applying a voltage to the metallic particles 42 so that the long axis of the metallic particles 42 is arrayed in the inter-voltage direction is known. Thus, one example of a method of rotating the metallic particles 42 is adopting a configuration (for example, an electrode) in which the directional adjuster 3 can generate an electric field in the filter unit 4, and applying the electric field to the metallic particles 42, arraying the metallic particles 42.

It is also possible to take advantage of these characteristics to provide two pairs of electrodes and adjust the voltage applied between the electrodes, rotating the metallic particles 42 in three dimensions. By rotating the metallic particles 42 in three dimensions, one optical filter has three surface plasmon resonance wavelengths, thus allowing for an optical filter capable of displaying full color using one optical filter, further improving light use efficiency.

### Second Embodiment

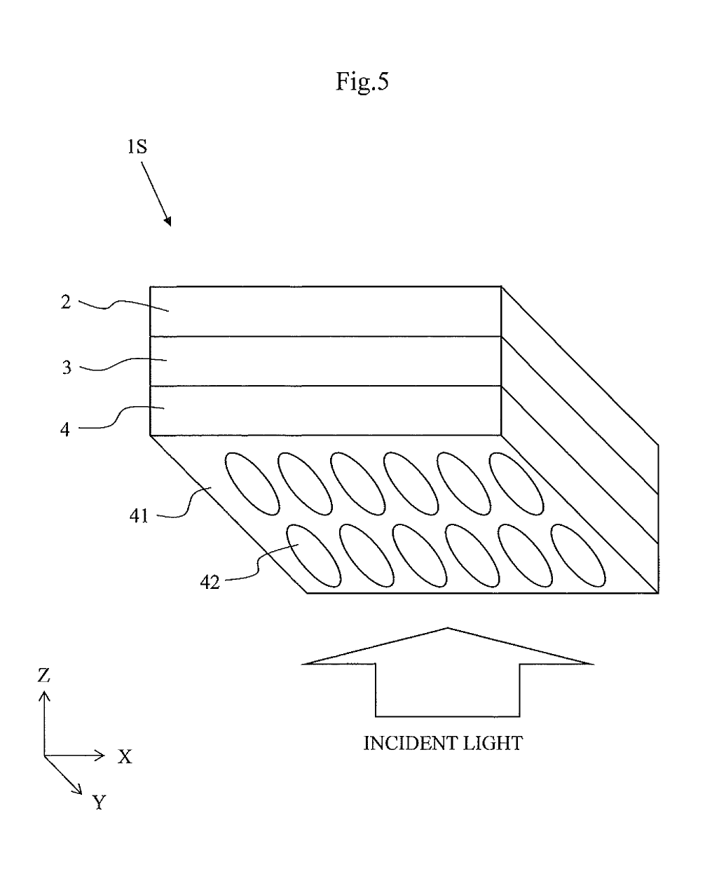

FIG. 5 is a schematic perspective view of an optical filter according to the present invention. The optical filter has essentially the same parts as the optical filter shown in FIG. 1 and the like, and the same labels will be appended to essentially identical parts, with detailed description thereof being omitted.

As shown in FIG. 5, a first optical filter 1S is a filter transmitting light of a specific wavelength region (absorbing light of a specific wavelength region) of incident light. The first optical filter 1S has a polarizing plate 2, a directional adjuster 3 (direction adjusting means), and a filter unit 4 disposed in the order the filter unit 4, the directional adjuster 3, and the polarizing plate 2 in the direction of light incidence (light source direction).

In the filter unit 4 shown in FIG. 5, it is better for there to be a greater amount of metallic particles 42 (in terms of amount per unit of area or volume), but when fellow metallic particles 42 contact each other or are too close together, different optical characteristics from those of a single particle may be obtained. It is known that, in order to prevent changes in optical characteristics, the distance between metallic particles 42 is preferably of at least a certain degree.

The directional adjuster 3 changes relatively the polarization of the transmitted light. The directional adjuster 3 is an optical element having liquid crystal, with a gap between a pair of flat electrode substrates disposed in parallel with a pre-determined spacing therebetween being filled with liquid crystal.

The directional adjuster 3 is not limited to using liquid crystal, and may, for example, use a Faraday element or a half-wave plate. A configuration in which a polarizing plate is rotated as the directional adjuster 3 is also possible. In this case, a configuration in which the directional adjuster 3 doubles as the polarizing plate 2 is also possible.

The polarizing plate 2 is for extracting only specific linearly polarized light from the transmitted light, and has a configuration identical to that of conventionally well-known polarizing plates. Light of a specific polarization is extracted from the transmitted light by passing through the polarizing plate 2. In the first optical filter 1S shown in FIG. 5, the polarizing plate 2 is disposed so as to extract light for which the polarization is the X direction (X-polarized light).

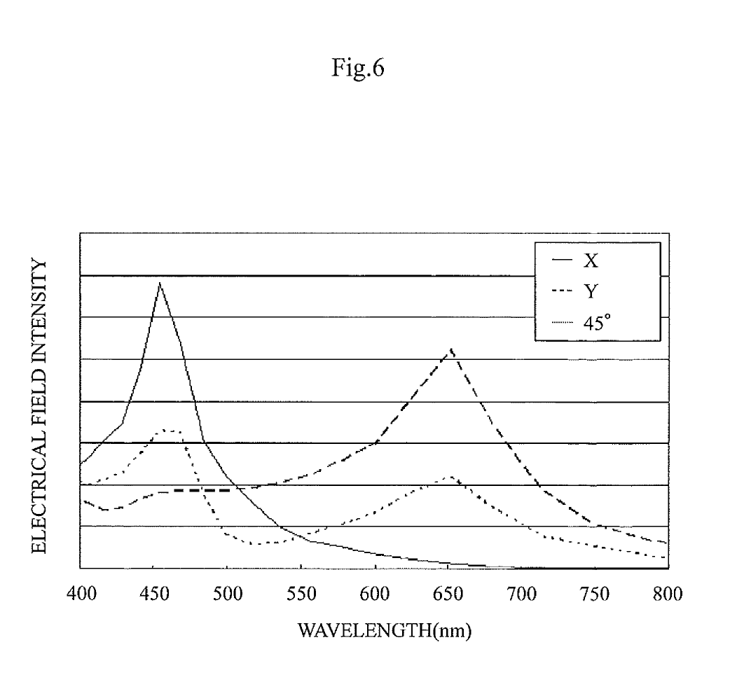

Next, the resonance spectrum of silver metallic particles arrayed in two dimensions will be described. FIG. 6 shows FDTD simulation results, the model of which is as follows. Elliptic cylindrical silver metallic particles of size 30 nm in length in the X direction, 60 nm in length in the Y direction, and 10 nm in length in the Z direction were arrayed with a 100 nm period in the XY plane. The incident light is a plane wave propagated in the Z direction, and the polarization is inclined 45° with respect to the X axis. FIG. 6 shows the intensities of X components, Y components, and 45° components of the electrical fields immediately after the field in which the metallic particles are arrayed in two dimensions.

FIG. 6 can be taken as the absorption spectrum for each component when light for which the polarization is the X direction, the Y direction, and the 45° direction is extracted from the light transmitted by the metallic particles. In the following description, a polarizing plate is disposed at the rear end of the light progression direction of metallic particles arrayed in two dimensions, the polarizing plate is moved, and light in the X direction, Y direction, and 45° direction is extracted.

FIG. 6 will now be described in light of the above considerations. In FIG. 6, when the polarization of the transmitted light extracted by the polarizing plate is 0° (X-polarized light), there is an absorption peak only in wavelengths in the vicinity of 460 nm; i.e., out of light transmitted through a field in which metallic particles are arrayed in two dimensions, X-polarized component wavelengths in the vicinity of 460 nm are absorbed in the far field. On the other hand, when the polarization of the transmitted light extracted by the polarizing plate is 90° (Y-polarized light), there is an absorption peak only in wavelengths in the vicinity of 650 nm; i.e., out of light transmitted through a field in which metallic particles are arrayed in two dimensions, Y-polarized component wavelengths in the vicinity of 650 nm are absorbed in the far field. When the polarization of the transmitted light extracted by the polarizing plate is 0° (X-polarized light)/90° (Y-polarized light), of the two peaks generated, it is possible to extract only the effects of absorption depending on the short axis/long axis of the metallic particles.

When the polarization of the transmitted light extracted by the polarizing plate is 45°, there is an absorption peak in wavelengths at both 460 nm (absorption peak when the polarization is 0°) and 650 nm (absorption peak when the polarization is 90°); i.e., when the polarization of the transmitted light extracted by the polarizing plate is 45°, light in which both wavelength components have been absorbed is outputted. It is thereby possible to have an absorption peak dependent on the short axis/long axis of the metallic particles by having an angle with the polarization of the transmitted light extracted by the polarizing plate that is parallel with neither of the anisotropic axes of the metallic particles.

As shown in FIG. 6, the electrical field intensity at 460 nm when the polarization of the transmitted light extracted by the polarizing plate is 45° is approximately half that of when the polarization is 0°. Similarly, the electrical field intensity at 650 nm when the polarization of the transmitted light extracted by the polarizing plate is 45° is approximately half that of when the polarization is 90°. It is thus possible to change the absorption intensity of the absorption peak depending on the ratio of the angles between the polarization of the transmitted light extracted by the polarizing plate and the two anisotropic axes of the metallic particles. In other words, it is possible to change the absorption intensity of the absorption peaks corresponding to each of two anisotropic directions of the metallic particles by adjusting the relative angle between the anisotropicity of the metallic particles and the polarization of the light transmitted by the polarizing plate.

Due to the phenomena described above, the shape and array of the metallic particles of the filter unit and the polarization of the transmitted light extracted by the polarizing plate may be adjusted as appropriate to set the position of the absorption peak of the optical filter at a desired position. In other words, the optical filter can have a desired absorption spectrum. In the simulation of FIG. 6, the incident light was polarized at 45°, but similar results can be obtained even when both X and Y polarization components are present, as in the case of random polarization or circular polarization.

In the first optical filter 1S of the present invention, the filter unit 4 has a configuration wherein metallic particles 42 are dispersed upon the transparent dielectric medium 41, and the metallic particles 42 are arrayed in two dimensions. In the first optical filter 1S, the polarization of the transmitted light transmitted by the filter unit 4 is adjusted by the directional adjuster 3. Light transmitted by the directional adjuster 3 is transmitted by the polarizing plate 2 to extract specific linearly polarized light (light of a specific polarization). A configuration wherein the polarization of the transmitted light transmitted by the filter unit 4 can be adjusted is thus present.

Here follows a description of the operation of the first optical filter 1S having such a configuration. As described above, out of incident light, the X-polarized component generates surface plasmon resonance corresponding to the size of the X direction of the metallic particles 42, and light of a wavelength region corresponding to the size of the X direction is absorbed (in FIG. 5, the X direction is the short axis of the metallic particles 42; when the metallic particles used in the simulation of FIG. 6 are used, the wavelength of the absorption peak is 460 nm).

Likewise, out of incident light, the Y-polarized component generates surface plasmon resonance corresponding to the size of the Y direction of the metallic particles 42, and light of a wavelength region resulting from the size of the Y direction is absorbed (in FIG. 5, the Y direction is the short axis of the metallic particles 42; when the metallic particles used in the simulation of FIG. 6 are used, the wavelength of the absorption peak is 650 nm).

In the first optical filter 1S shown in FIG. 5, when the polarization of the polarizing plate 2 is the X direction (X-polarized light), light outside of a wavelength region (around 460 nm) corresponding to the X direction of the metallic particles 42 is transmitted when the directional adjuster 3 does not rotate the polarization of light transmitted by the filter unit 4. In other words, light having an absorption peak in a wavelength region corresponding to the size of the X direction of the metallic particles 42 (light forming the X direction component) is transmitted.

On the other hand, when the directional adjuster 3 rotates the polarization of light transmitted by the filter unit 4 by 90°, light outside of a wavelength region (around 650 nm) corresponding to the size of the Y direction of the metallic particles 42 is transmitted. In other words, light having an absorption peak in a wavelength region corresponding to the size of the Y direction of the metallic particles 42 (light forming the Y direction component) is transmitted.

When the directional adjuster 3 is adjusted and the polarization of the light transmitted by the filter unit 4 is rotated in a range between 0° and 90°, light having an X direction component and a Y direction component is transmitted. The light transmitted by the filter unit 4 generates surface plasmon resonance for the X direction and surface plasmon resonance for the Y direction of the metallic particles 42, and the transmitted light extracted by the polarizing plate 2 is superimposed by the ratio of the intensities cast by the X direction component and Y direction component polarization set by the directional adjuster 3 for light transmitted by the filter unit 4. For example, the X direction component becomes greater the closer to 0° the polarization of the transmitted light is, and the Y direction component becomes greater the closer to 90° the polarization is.

From the foregoing, the absorption spectrum of transmitted light from the first optical filter 1S can be adjusted by rotating the polarization of light transmitted by the filter unit 4 using the directional adjuster 3 and adjusting the polarization of the transmitted light extracted by the polarizing plate 2. It is thereby possible to reproduce a wide range of colors using one first optical filter 1S.

The first optical filter 1S of the present invention can be configured to have an absorption peak at two surface plasmon resonance wavelengths corresponding to the long axis and short axis of the metallic particles 42 (in FIG. 5, the Y direction and the X direction). It is thereby possible to appropriately select metallic particles 42 in the first optical filter according to the present invention to obtain a first optical filter that produces red and blue and a first optical filter that produces green (and red), allowing for full color display using two first optical filters. As opposed to a conventional optical filter (for example, a color filter divided into RGB), in which the absorption wavelength is fixed, it is possible to improving light use efficiency to the extent that the number of optical filters is reduced.

In the case described above, the relationship between the metallic particles 42 and the polarization of the light extracted by the polarizing plate 2 was adjusted by the directional adjuster 3 rotating the polarization of light transmitted by the filter unit 4, but the invention is not limited to this. For instance, a configuration in which the directional adjuster rotates the metallic particles 42 is also possible. In such a case, the transparent dielectric medium 41 is preferably a gel or liquid so that the metallic particles 42 can rotate easily. Namely, an identical optical filter can be obtained even when the relationship with the polarization of the light extracted by the polarizing plate 2 is adjusted by rotating the metallic particles 42.

A technique of applying a voltage to the metallic particles 42 so that the long axis of the metallic particles 42 is arrayed in the inter-voltage direction is known. Thus, one example of a method of rotating the metallic particles 42 is adopting a configuration (for example, an electrode) in which the directional adjuster 3 can generate an electric field in the filter unit 4, and applying the electric field to the metallic particles 42, arraying the metallic particles 42.

It is also possible to take advantage of these characteristics to provide two pairs of electrodes and adjust the voltage applied between the electrodes, rotating the metallic particles 42 in three dimensions. By rotating the metallic particles 42 in three dimensions, one optical filter has three surface plasmon resonance wavelengths, thus allowing for an optical filter capable of displaying full color using one optical filter, further improving light use efficiency compared to a conventional color filter.

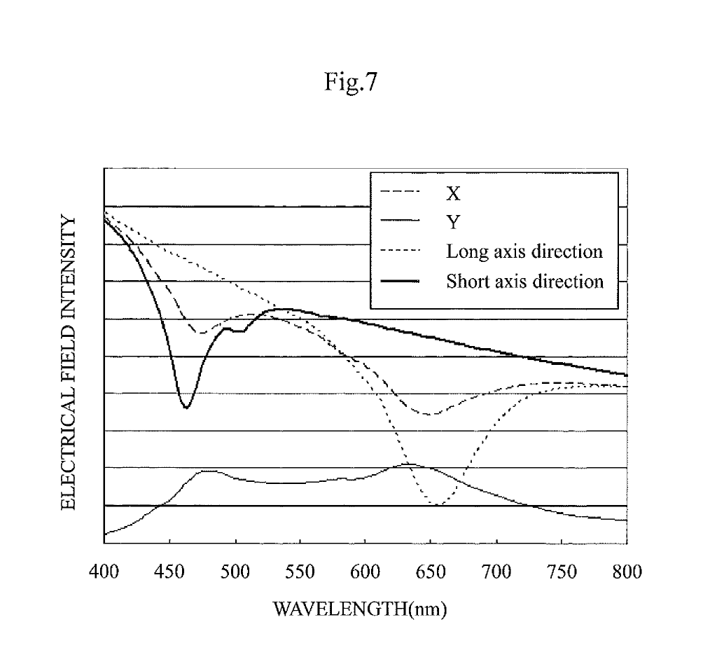

Next, a case in which the incident light is linearly polarized light will be considered in detail. FIG. 7 shows the results of an FDTD simulation of a far field transmission spectrum. The dashed line is an X component, the solid line is a Y component, the dotted line is a component in the long axis direction of the metallic particles 42, and the bold line is a short axis direction component. The incident light polarization is the X direction, and the metallic particles 42 are disposed tilted to a 45° angle. The shape of the metallic particles 42 is the same as in the simulation of FIG. 6, and there are eight layers with a spacing of 200 nm therebetween.

It can be seen that, for the X component of the light transmitted by the filter unit 4, light of the surface plasmon resonance wavelength for the long axis direction of the metallic particles 42 (650 nm) and light of the surface plasmon resonance wavelength for the short axis direction (460 nm) is absorbed, and light of other wavelengths is transmitted. On the other hand, it can be seen that, for the Y component, transmission is such that light of the surface plasmon resonance wavelength for both the long axis and short axis directions is scattered.

Because the polarization of the light irradiating the metallic particles 42 is tilted 45°, surface plasmon resonance is generated in both the long axis direction and the short axis direction of the metallic particles 42. When the X component of the light transmitted by the filter unit 4 is extracted, the polarization is the same as the incident light, so that light of a wavelength such that surface plasmon resonance does not occur is transmitted, and light of the surface plasmon resonance wavelength appears to be absorbed. On the other hand, when the Y component of the light transmitted by the filter unit 4 is extracted, the polarization is orthogonal to that of the incident light, so that light of a wavelength such that surface plasmon resonance does not occur is not transmitted, and light of the surface plasmon resonance wavelength appears to be scattered.

By taking advantage of this phenomenon, a first optical filter can produce color as described below.

When the incident light polarization is set so as to be neither parallel nor perpendicular with respect to the orientation of the metallic particles 42, by adjusting the polarization of transmitted light extracted by the polarizing plate 2 using the directional adjuster 3 so as to be parallel to the incident light polarization, absorption of surface plasmon resonance in the long axis and short axis directions is viewed, allowing a color complementary to the long axis and short axis direction surface plasmon resonance wavelengths to be produced. In FIG. 7, the surface plasmon resonance wavelength for the long axis direction is approximately 650 nm (red), the surface plasmon resonance wavelength for the short axis direction is approximately 460 nm (blue), and green, which is a complementary color of these, can be produced.

On the other hand, by adjusting the directional adjuster 3 so that the polarization of transmitted light extracted by the polarizing plate 2 is set so as to be perpendicular to the incident light polarization, scattering due to surface plasmon resonance in the long axis and short axis directions is viewed, allowing for a color of the surface plasmon resonance wavelength for the long axis and short axis directions, i.e., purple, to be produced.

By adjusting the directional adjuster 3 so that the polarization of transmitted light extracted by the polarizing plate 2 is set as the long axis direction of the metallic particles 42, absorption of surface plasmon resonance in the long axis direction is viewed, allowing for a color complementary to the surface plasmon resonance wavelength for the long axis direction, i.e., blue-green, to be produced. On the other hand, by adjusting the directional adjuster 3 so that the polarization of transmitted light extracted by the polarizing plate 2 is set as the short axis direction of the metallic particles 42, absorption of surface plasmon resonance in the short axis direction is viewed, allowing for a color complementary to the surface plasmon resonance wavelength for the short axis direction, i.e., yellow, to be produced.

Thus, by tilting the incident light polarization with respect to the orientation of the metallic particles 42, operating the directional adjuster 3, and adjusting the polarization of transmitted light extracted by the polarizing plate 2 by 45° each, it is possible to produce blue- green, purple, blue, and yellow.

As can be seen from FIG. 7, the position of the peak when the directional adjuster 3 is adjusted and the polarization of transmitted light extracted by the polarizing plate 2 is set to the long axis/short axis directions of the metallic particles 42 is different from when the polarization is tilted 45°. It is believed that this is caused by being subjected to the effects of surface plasmon resonance of a direction other than the complete long axis/short axis directions when the incident light polarization is tilted 45°. In other words, one may take advantage of this phenomenon to adjust absorption wavelength.

In the above description, the directional adjuster 3 rotated the polarization of transmitted light extracted by the polarizing plate 2, but it may also adjust the direction of the metallic particles 42. However, in this case, the relative angle with the incident light polarization must also be adjusted. For example, when the incident light polarization and the direction of the metallic particles 42 are parallel or perpendicular, it is not possible to produce four colors as described above. Also, even when the incident light polarization and the direction of the metallic particles 42 are in states neither parallel nor perpendicular to each other, the proportions contributed by surface plasmon absorption corresponds to long axis direction and short axis direction changes.

### Third Embodiment

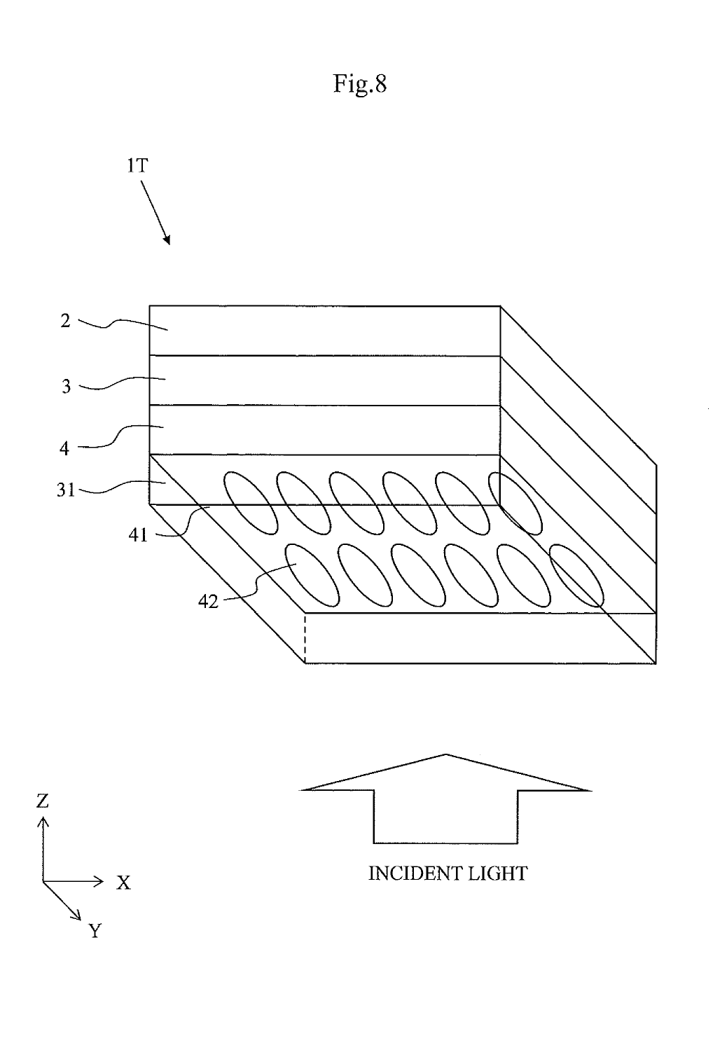

Next, another example of an optical filter according to the present invention will be described with reference to the drawings. FIG. 8 is a perspective view of another example of an optical filter according to the present invention. As shown in FIG. 8, a second optical filter 1T has a second directional adjuster 31 on a surface opposite that of the directional adjuster 3 of the filter unit 4. Other portions are configured identically to the first optical filter 1S shown in FIG. 5, and essentially identical parts will have the same labels. Specifically, the second optical filter IT differs from the first optical filter 1S in that the second directional adjuster 31 is used to adjust the incident light polarization.

The second directional adjuster 31, like the directional adjuster 3, may be an optical element having liquid crystal, or may be a Faraday element or half-wave plate. In this case, the incident light is linearly polarized light. The polarizing plate may be rotated, in which case the incident light need not be linearly polarized light.

For example, by adjusting the second directional adjuster 31, setting the incident light polarization and the long axis direction of the metallic particles 42 parallel to each other, adjusting the directional adjuster 3, and setting the polarization of transmitted light and the long axis direction of the metallic particles 42 parallel to each other, absorption by the long axis direction surface Plasmon resonance of the metallic particles 42 is viewed. The second optical filter IT thereby outputs a color complementary to the surface plasmon resonance wavelength in the long axis direction of the metallic particles 42.

By adjusting the second directional adjuster 31, setting the incident light polarization to be perpendicular with respect to the long axis direction of the metallic particles 42 (parallel to the short axis direction), adjusting the directional adjuster 3, and setting the transmitted light polarization to be parallel to the incident light polarization, absorption of surface plasmon resonance in the short axis direction of the metallic particles 42 is viewed, allowing a color complementary to the short axis direction surface Plasmon resonance wavelength to be produced.

Using the second optical filter 1T having a configuration of this sort, light use efficiency is improved compared to when light of the same wavelength is transmitted by the first optical filter 1S in which the incident light polarization and the long axis direction of the metallic particles 42 is not parallel nor perpendicular (for example, the incident light polarization is tilted 45° with respect to the long axis direction of the metal). On the other hand, by adjusting the directional adjuster 3, and setting the polarization of transmitted light to be perpendicular to the incident light polarization yielded by the second directional adjuster 31, light from the light source is not transmitted, allowing black to be produced.

In the second optical filter 1T, even when the polarization of the light outputted by the light source differs from a predetermined (in the design or the like) direction, the second directional adjuster 31 can be adjusted and the incident light polarization can be set to be predetermined polarization. There are few limits on the light source used to obtain an optical filter having a desired absorption spectrum. Furthermore, even when a light source whose polarization is not adjusted is used, it is possible to have a desired absorption spectrum with the second optical filter 1T.

In the above description, the second directional adjuster 31 adjusts the incident light polarization, but a configuration in which the direction of the metallic particles 42 is adjusted is also possible. In this case, the directional adjuster 3 must adjust the polarization of transmitted light extracted by the polarizing plate 2 with consideration also given to the direction of the metallic particles 42.

In the first optical filter IS and the second optical filter 1T, the transmitted light can be changed so as to have an absorption spectrum in a desired wavelength region by adjusting the polarization of transmitted light. It is thereby possible to reproduce a wide range of colors (for example, from two to four colors) using one optical filter.

### Fourth Embodiment

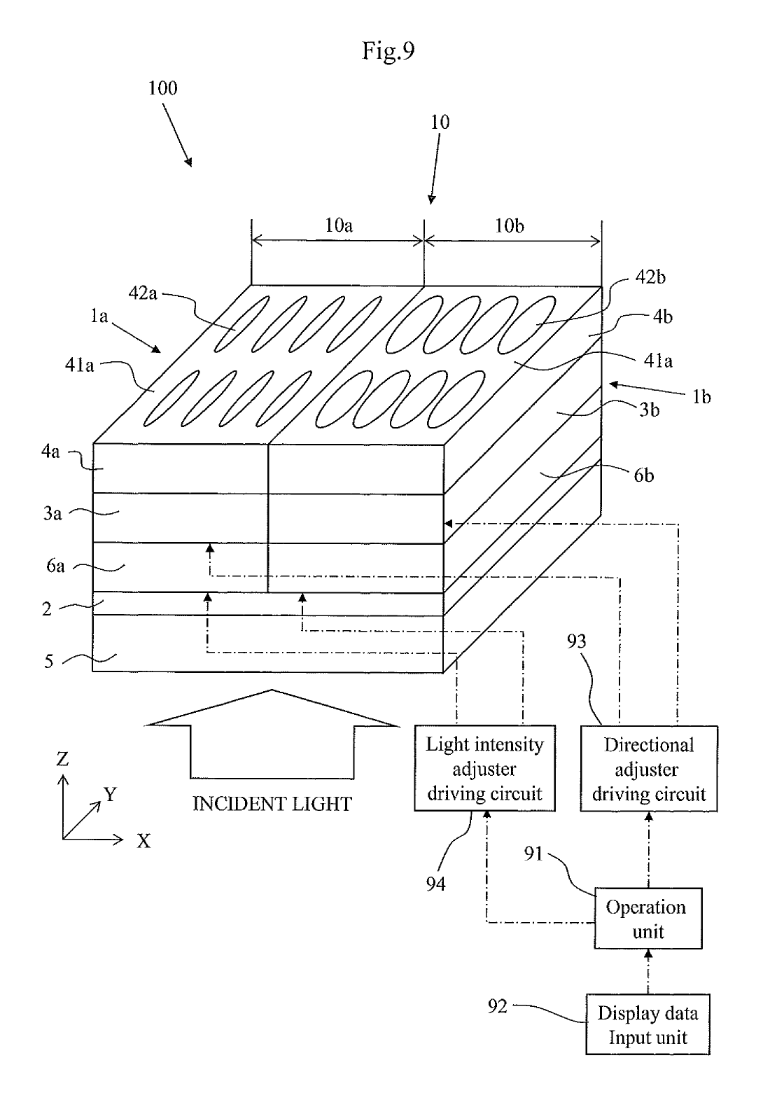

Next, a display according to the present invention will be described with reference to the drawings. FIG. 9 is an outline of the configuration of one example of a display according to the present invention. For the sake of ease in description, the display 100 shown in FIG. 9 has one display cell 10 in its configuration, but, in actuality, a plurality of display cells 10 are arrayed in a vertical and horizontal matrix (for example, 1,080 units vertically by 1,920 units horizontally). The display cell 10 will be primarily described in the following description. The display 100 is a transmission display, and is viewed by a viewer from a side of optical filters 1a, 1b (filter units 4a, 4b).

As shown in FIG. 9, the display 100 has the display cell 10, an operation unit 91, a display data input unit 92, a direction adjuster driving circuit 93, and a light intensity adjuster driving circuit 94.

The display cell 10 is divided into subcells 10a, 10b aligned in the X direction, and has the optical filters 1a, 1b and a light source 5. The optical filters 1a, 1b are disposed aligned in the X direction. The subcell 10a and the subcell 10b are each capable of different displays (displaying different colors).

The light source 5 needs only to emit visible light. When performing full color display, a light source 5 emitting white light is preferred. Examples of light source 5 include a fluorescent light, an incandescent bulb, an LED, a laser light source, or the like. A diffuser panel or a light-guiding panel that irradiates the light from the light source 5 over a whole surface may be provided. When the light source is one that outputs linearly polarized light, as, for example, a laser light source, the polarizing plate 2 may be omitted.

The optical filter 1a has a polarizing plate 2, a directional adjuster 3a, and a filter unit 4a, as well as a light intensity adjuster 6a between the polarizing plate 2 and the directional adjuster 3a. Likewise, the optical filter 1b has a polarizing plate 2, a directional adjuster 3b, and a filter unit 4b, as well as a light intensity adjuster 6b between the polarizing plate 2 and the directional adjuster 3b. The polarizing plate 2 is a member shared by the optical filters 1a, 1b. In the following description, the directional adjusters 3a, 3b are liquid crystal elements adjusting the incident light polarization, but are not limited to this as long as they relatively change the incident light polarization and the anisotropic orientation of metallic particles 42a, 42b.

In the optical filter 1a and 1b, the polarizing plate 2, direction adjusting means 3a, 3b, and filter units 4a, 4b (transparent dielectric media 41a, 41b and metallic particles 42a, 42b) are as in the optical filter 1 described above, but the metallic particles 42a has different shapes in the optical filter 1a from those in the optical filter 1b. For example, when the subcell 10a displays mixture colors of red and blue and the subcell 10b displays green, three primary colors can be produced by the display cell 10.

Because the human eye has low sensitivity to red, when red is displayed by the subcell 10a alone, the intensity of the incident light must be increased. When the subcell 10a and the subcell 10b are both made capable of displaying red, as the aperture ratio for red increases the intensity of the incident light need not be increased. Due to the foregoing considerations, in the display cell 10, the subcell 10a displays red and blue, and the subcell 10b displays red and green. The optical filter 1a produces both red and blue, and the optical filter 1b produces both red and green.

In the display cell 10 shown in FIG. 9, the subcell 10a displays red and blue, and thus has metallic particles 42a so that the filter unit 4a has absorption peaks in the two wavelength regions of 490 to 500 nm and 580 to 595 nm. The subcell 10b displays green and red, and thus has metallic particles 42b so that the filter unit 4b has absorption peaks in the two wavelength regions of 750 to 800 nm and 490 to 500 nm.

The light intensity adjusters 6a, 6b adjust the intensity of the light irradiating the metallic particles 42a, 42b (in other words, the transmission of the light). By the light intensity adjuster 6a and 6b, a combination of a polarizing plate and a liquid crystal element, a pair of the optical filter 1a and 1b shows a desired color. Each of the liquid crystal elements of the light intensity adjusters 6a, 6b rotates the polarization of light after the polarizing plate 2 so that the polarizing plates of the light intensity adjuster 6a and 6b transmit a desired fraction of light. The light transmitted by the light intensity adjusters 6a, 6b at this point has a constant polarization, and the directional adjusters 3a, 3b can perform the operation described above for the optical filter 1.

An electrochromic material whose color changes when an electrical charge is applied thereto may be used for the light intensity adjusters 6a, 6b. By applying a voltage to the light intensity adjusters 6a, 6b for which an electrochromic material was used, it is possible to change the intensity (transmission) of the transmitted light. In this embodiment, the light intensity adjusters 6a, 6b are disposed between the polarizing plate 2 and the directional adjusters 3a, 3b, but they may also be disposed between the polarizing plate 2 and the light source 5, or upon the filter units 4a, 4b (on the viewer side).

The direction adjuster driving circuit 93 is for sending an electronic signal to the directional adjusters 3a, 3b on the basis of data received from the operation unit 91, and rotating incident linearly polarized light to a desired polarization. The light intensity adjuster driving circuit 94 sends an electronic signal to the light intensity adjusters 6a, 6b on the basis of data received from the operation unit 91, and controls the intensity of light transmitted by the light intensity adjusters 6a, 6b. In the case of a configuration having an individual light source 5 for each of the subcells 10a, 10b, a configuration in which the light intensity adjuster driving circuit 94 sends an electronic signal to the each light source 5 and adjusts the luminescent intensity is possible. In this case, the light intensity adjusters 6a, 6b may be omitted, and the light transmission can be increased.

Because the directional adjusters 3a, 3b are liquid crystal elements, electrodes disposed in opposition to each other are provided. Electrodes are provided sandwiching the liquid crystal elements in the light intensity adjusters 6a, 6b as well. The electrodes are preferably transparent if possible, and, for example, a transparent electrode such as indium tin oxide (ITO) or indium zinc oxide (IZO) can be used. A shared electrode (for example, a grounding electrode) may be provided in a central position between the directional adjuster 3a and the light intensity adjuster 6a or the directional adjuster 3b and the light intensity adjuster 6b.

The display data input unit 92 is a part into which image or video data to be displayed on the display 100 received from for example, a disc device such as a DVD player or a Blu-ray disc player, a PC, or the like is inputted. Examples of the inputted image or video data include data having color and brightness data for each display cell 10. In order to display the image or video data received from the display data input unit 92 on the display cells 10, the operation unit 91 includes a processing circuit that calculates the intensity and polarization of the light incident on each of the cells, and outputs the results to each of the cells 10.

Next, the operation of the display 100 will be described. First, the image/video data is inputted to the display data input unit 92. The operation unit 91 determines the color and intensity of each of the display cells 10 on the basis of the image/video data, and calculates the polarization of the light incident on the filter units 4a, 4b and the intensity of the incident light based on the color info nation. The operation unit 91 sends a signal containing incident light polarization information to the direction adjuster driving circuit 93, and a signal containing intensity information to the light intensity adjuster driving circuit 94.

The direction adjuster driving circuit 93 sends a drive signal to the directional adjusters 3a, 3b on the basis of the signal received from the operation unit 91. The light intensity adjuster driving circuit 94 sends a drive signal to the light intensity adjusters 6a, 6b on the basis of the signal received from the operation unit 91. The drive signal sent to the directional adjusters 3a, 3b is an independent signal, and applies a voltage for driving the liquid crystal element to the electrode substrate. Likewise, the drive signal sent to the light intensity adjusters 6a, 6b is an independent signal, and applies a voltage for driving the liquid crystal element to the electrode substrate.

By receiving the drive signal from the light intensity adjuster driving circuit 94, the light intensity adjuster 6a and 6b adjust the transmission of the light from the light source 5, and adjusts the intensity of the light incident on the directional adjusters 3a, 3b. On the other hand, by receiving the drive signal from the direction adjuster driving circuit 93, the directional adjusters 3a, 3b rotationally adjusts the incident light polarization. After the polarization and intensity thereof adjusted by the light intensity adjusters 6a, 6b and the directional adjusters 3a, 3b, the incident light enters the filter units 4a, 4b. The light of the wavelength region determined by the anisotropicity of the metallic particles 42a, 42b and the polarization is absorbed in the filter units 4a, 4b. A desired color is thereby displayed by the subcells 10a, 10b; i.e., by the display cell 10.

Hereafter follows a description of red, green, blue, intermediate colors thereof, white, and black each being displayed by a display cell 10 according to the present invention.

Hereafter follows a description of red being displayed. The direction adjuster driving circuit 93 controls the directional adjusters 3a, 3b so as to adjust the polarization of the light incident on the filter units 4a, 4b so that red is displayed. The light intensity adjuster driving circuit 94 controls the light intensity adjusters 6a, 6b, and sets the intensity of the light incident on the directional adjusters 3a, 3b to an optimal intensity. By controlling each part of the display cell 10 in this way, red is displayed by the subcells 10a, 10b. The display cell 10 thereby displays red (displays red in the far field).

Hereafter follows a description of green being displayed. The direction adjuster driving circuit 93 controls the directional adjuster 3b so as to adjust the polarization of the light incident on the filter unit 4b so that green is displayed. The light intensity adjuster driving circuit 94 controls the light intensity adjuster 6b, and sets the intensity of the light incident on the directional adjuster 3b to an optimal intensity. The light intensity adjuster driving circuit 94 controls the light intensity adjuster 6a, and it prevents light from entering into the directional adjuster 3a (sets the incident light intensity to zero). By controlling each part of the display cell 10 in this way, the subcell 10a displays nothing (i.e., displays black), and the subcell 10b displays green. The display cell 10 thereby displays green (displays green in the far field).

Hereafter follows a description of blue being displayed. The direction adjuster driving circuit 93 controls the directional adjuster 3a so as to adjust the polarization of the light incident on the filter unit 4a so that blue is displayed. The light intensity adjuster driving circuit 94 controls the light intensity adjuster 6a, and sets the intensity of the light incident on the directional adjuster 3a to an optimal intensity. The light intensity adjuster driving circuit 94 controls the light intensity adjuster 6b, and it prevents light from entering into the directional adjuster 3b (sets the incident light intensity to zero). By controlling each part of the display cell 10 in this way, the subcell 10a displays blue, and the subcell 10b displays nothing (i.e., displays black). The display cell 10 thereby displays blue (displays blue in the far field).

By suitably adjusting the relative intensities of red, blue, and green, intermediate colors can be displayed. By setting the subcell 10a to display red and blue, and the subeell 10b to display green or, red and green, the display cell 10 displays white.

When the subcell 10b is set to display green and yellow, pseudo white can be displayed on the display cell 10 by displaying blue on the subcell 10a and yellow on the subeell 10b. Other color combinations are also possible when the colors are mutually complementary. By setting the subcell 10a to display blue and red, and the subcell 10b to display green and yellow, a brighter white can be produced.

When displaying black, the light intensity adjuster driving circuit 94 need only adjust the light intensity adjusters 6a, 6b so that no light enters the filter units 4a, 4b.

As described above, the display 100 uses the optical filters 1a, 1b according to the present invention, and is capable of displaying two colors and a mixture thereof on one subcell by adjusting the relative angles of the anisotropicity of the metallic particles 42a, 42b and the polarization of the light source. It is thereby possible to reduce the number of filters needed to display full color to two or less.

In a conventional color filter with separate RGB coated sections, a display cell has a red (R) display subcell, a green (G) display subcell, and a blue (B) display subcell. When, for example, red (R) is displayed, the green (G) display subcell and the blue (B) display subcell are darkened, and two pixels are unlit. In other words, when red (R), green (G), and blue (B), are displayed, a 66% unlit field is generated in a conventional display cell.

In the display cell 10 according to the present invention, as described above, color can tuned by controlling the polarization, so that subcells 10a, 10b are lit when red is displayed, generating no unlit field. When green is displayed, the subcell 10a is unlit, and when blue is displayed, the subcell 10b is unlit, shrinking the unlit field from 66% to 50% and increasing light use efficiency, allowing for brighter display or for reduced energy consumption for the same display.

Along with the two resonance wavelengths corresponding to the long axis and the short axis, the optical filter of the present invention can apply a polarization between the long axis and the short axis and shift the surface plasmon resonance peak to add a third resonance wavelength. By using such an optical filter, it is possible to produce all of RGB (light of wavelengths corresponding to RGB) in full color as necessary with one optical filter, and the display cell can display full color using one optical filter, i.e., one subcell. In this case, the unlit field disappears, enabling for further light use efficiency improvement. The direction adjuster driving circuit 93 and light intensity adjuster driving circuit 94 can also be simplified.

The filter units 4a, 4b are not limited to the above description, and when a configuration is adopted wherein the filter unit 4a has an absorption peak in the two wavelength regions of 490 to 500 nm and 580 to 595 nm, the filter unit 4b need only display at least green, and the filter unit 4b need only have an absorption peak at 750 to 800 nm. Through as configuration of this sort, it is possible to display mixture colors of blue and red on subcell 10a, and green on subcell 10b, allowing for full color display by the display cells 10. By setting another absorption peak of the filter unit 4b at 435 to 480 nm, the subcell 10b can display yellow as a complementary color. Because the subcell 10a can display red and blue, and the subcell 10b can display green and yellow, high-detail color production of four primary colors, RGBY, is possible. By displaying blue on the subcell 10a and yellow on the subcell 10b, it is possible to display pseudo white. By configuring the filter unit 4b so as to have an absorption peak as 750 to 800 nm, and another absorption peak outside the visible spectrum (less than 400 nm or 800 nm or greater), the subcell 10b can display white.

### Fifth Embodiment

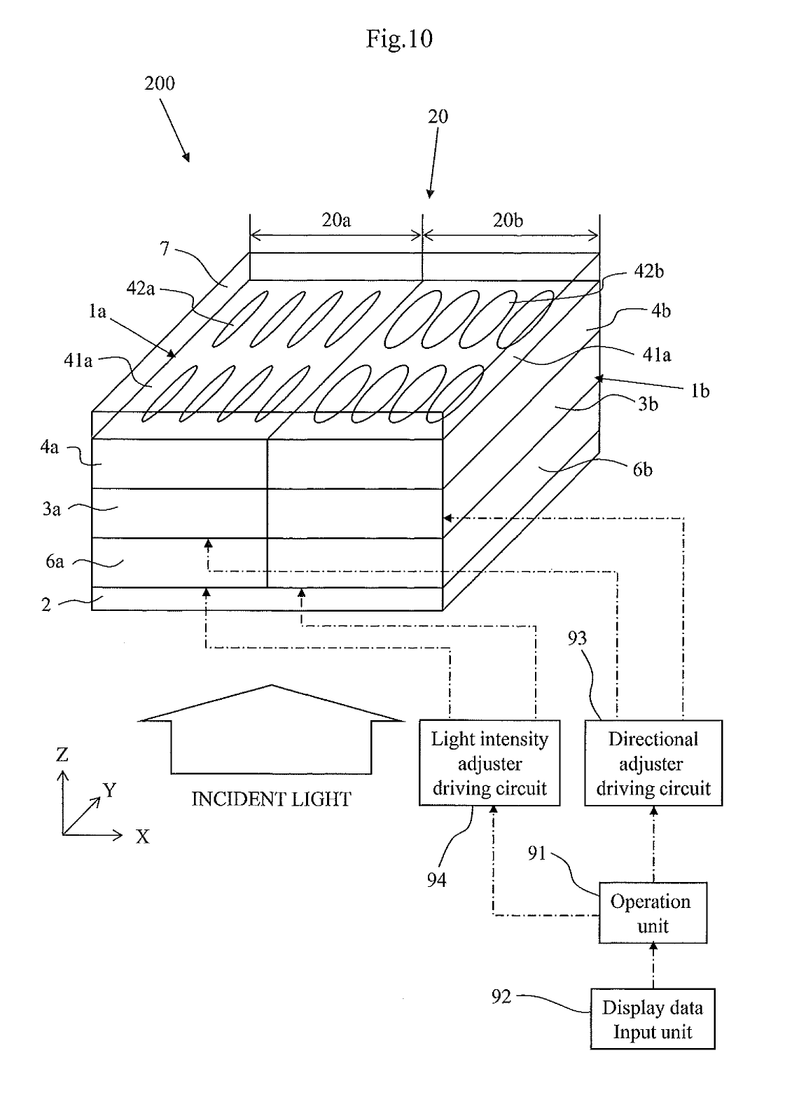

Another example of a display according to the present invention will be described with reference to the drawings. FIG. 10 is an outline of another example of a display according to the present invention. Pails of a display 200 shown in FIG. 10 that are essentially the same as in the display 100 will have the same labels, and detailed description of essentially same parts will be omitted, Whereas the display 100 shown in FIG. 9 was a transmission display, the display 200 according to this embodiment is a reflective display. As in FIG. 9, FIG. 10 shows a display 200 configured so as to have one display cell 20, but the actual display has a plurality of display cells 20 arrayed in a matrix.

As shown in FIG. 10, the display cell 20 is a reflective display cell, and incident light from the polarizing plate 2 is transmitted by the filter units 4a, 4b, scattered, transmitted again by the filter units 4a, 4b, and outputted from the polarizing plate 2. Thus, the display cell 20 has no light source, and instead has a scattering layer 7 on a rear surface side (side opposite the directional adjusters 3a, 3b) of the filter units 4a, 4b.

The scattering layer 7 scatters unabsorbed light transmitted by the filter units 4a, 4b and transmits it through the filter units 4a, 4b again, making the absorption by the filter units 4a, 4b more complete and returning light of wavelengths other than those absorbed by the filter units 4a, 4b to the polarizing plate 2. The scattering layer 7 preferably has as high a scattering efficiency with respect to all wavelengths of the visible spectrum as possible, and may be a substrate with fine bumps formed thereupon, a diffuser panel, or the like.

Light enters from the polarizing plate 2 side, surface plasmon resonance in the metallic particles 42a, 42b of the filter units 4a, 4b is caused through the operation described for the first embodiment, and a specific wavelength is absorbed. However, because there are spaces between the plurality of metallic particles 42a, 42b of the filter units 4a, 4b, it is not possible to absorb 100% of the light of the absorption wavelength. In other words, part of the incident light passes through the spaces between the metallic particles 42a, 42b, and absorption due to surface plasmon resonance is not performed.

Unabsorbed light reaching the scattering layer 7 becomes returning light. Because the returning light is scattered at the scattering layer 7, the light often follows a light path different from the light path of incidence. Because the returning light follows a different light path, most of the returning light excites surface plasmon resonance in the metallic particles 42a, 42b. Thus, when the returning light once again passes through the optical filters 1a, 1b, the specific wavelength is further absorbed, allowing for more distinct color production.

To produce black in the display cell 20, light can be absorbed by the light intensity adjusters 6a, 6b. Both of these may be used. To produce white in the display cell 20, one surface plasmon resonance wavelength of the metallic particles 42a, 42b need only be set at a wavelength outside the visible spectrum (less than 400 nm, or 800 nm or greater) so that visible light is not absorbed by the filter units 4a, 4b. Alternatively, the metallic particles 42 may be rotated three dimensionally in the optical filter 1a,1b, a color other than white displayed in the optical filter 1a,1b, and a separate optical filter displaying only white provided.

If the filter unit 4a is set to produce red and blue, and the filter unit 4b set to produce green, half of the light is absorbed by the metallic particles, but half can be reflected and white displayed. In this embodiment, the light intensity adjusters 6a, 6b are disposed between the polarizing plate 2 and the directional adjusters 3a, 3b, but they may also be disposed on the light incident side of the polarizing plate 2 (on the viewer side), or between the filter units 4a, 4b and the scattering layer 7. The polarizing plate 2 and directional adjusters 3a, 3b may also be disposed, like the optical filter 1S, on the transmitting side of the filter units 4a, 4b; i.e., between the filter units 4a, 4b and the scattering layer 7.

In this embodiment, as in the first embodiment, it is possible to display full color using two optical filters 1a, 1b, and because the unlit field can be reduced from 66% to 50% and the aperture ratio increased compared to when a conventional color filter is used, light use efficiency can be improved.

### Sixth Embodiment

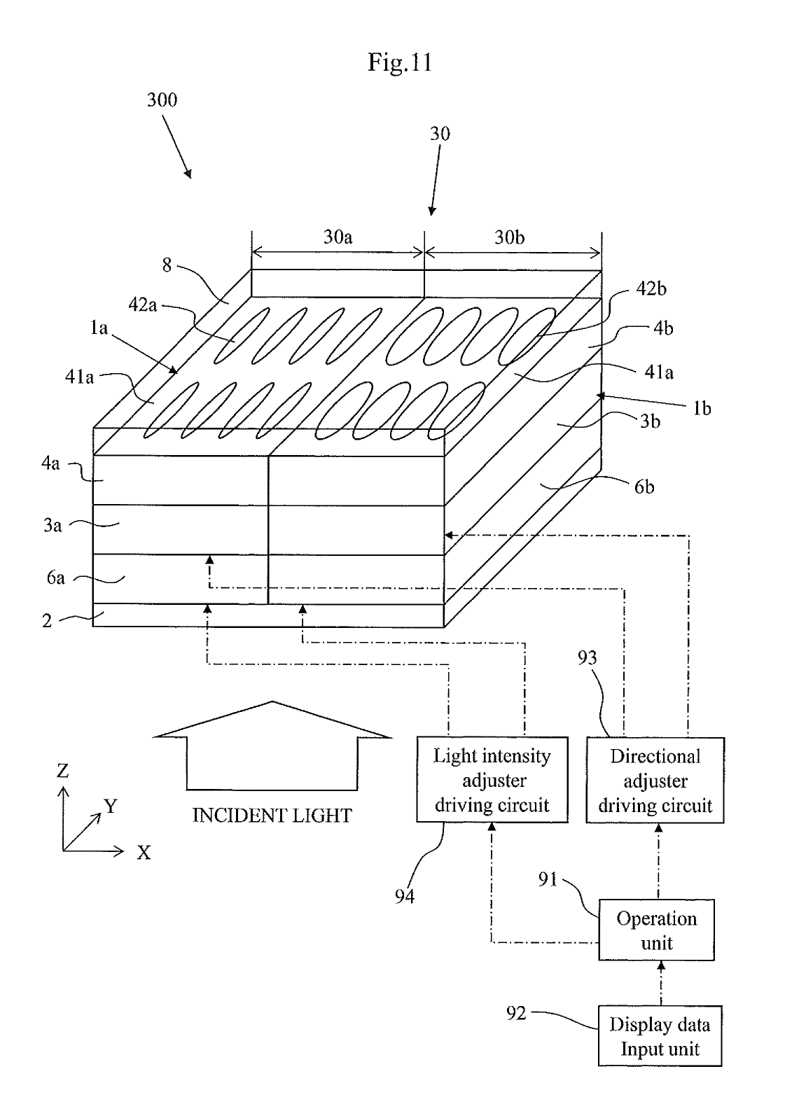

Yet another example of a display according to the present invention will be described with reference to the drawings. FIG. 11 is an outline of the configuration of yet another example of a display according to the present invention. Parts of a display 300 shown in FIG. 11 that are essentially the same as in the display 200 will have the same labels, and detailed description of essentially same parts will be omitted. Whereas the display 200 shown in FIG. 10 was a reflective display, the display 300 according to this embodiment is a scattering display. As in FIGS. 9 and 10, FIG. 11 shows a display 300 configured so as to have one display cell 30, but the actual display has a plurality of display cells 30 arrayed in a matrix.

As shown in FIG. 11, the display cell 30 of the display 300 has subcells 30a, 30b. The subcells 30a, 30b have optical filters 1a, 1b, and an anti-reflective layer 8 is provided on the rear side (side opposite the directional adjusters 3a, 3b of the filter units 4a, 4b).

The anti-reflective layer 8 prevents the reflection of transmitted light not absorbed by the filter units 4a, 4b. The layer need only have as low a reflectance for all wavelengths of the visible spectrum as possible, and multilayer membrane, moth eye structure, or photonic crystal, generally used as the anti-reflective coating, may be used. The material is preferably one having a high absorption coefficient along a broad range of the visible spectrum, and may be, for example, an inorganic material such as silicon, or a black resin in general use.

Light enters from the polarizing plate 2 side, and surface plasmon resonance in the metallic particles 42a, 42b of the filter units 4a, 4b is excited through the operation described for the first embodiment. In the surface plasmon resonance, scattering occurs along with absorption. Thus, while wavelengths other than the resonance wavelength are primary in a transmission display, when wavelengths other than the resonance wavelength are absorbed by the anti-reflective layer 8 so as not to be reflected, as in this embodiment, an viewer see only (rearward) scattered light in the resonance wavelength.

A specific example will be described below. For example, in the display cell 30, when the optical filter 1a has a filter unit 4a having metallic particles 42a having surface plasmon resonance spectrum properties as shown in FIG. 3, the peak at 455 nm corresponds to blue, and the peak at 650 nm corresponds to red. In other words, mixture colors of red and blue can be displayed in the subcell 30a.

Meanwhile, the optical filter 1b has a filter unit 4b having one surface plasmon resonance peak at 500 to 560 nm, and green is displayed in the subeell 30b. When one surface plasmon resonance peak of the filter unit 4b is at 580 to 595 nm, the subcell 30b is capable of producing yellow, and production of four primary colors in high detail is possible.

Because the human eye has low sensitivity to red, when red is displayed by the subcell 30a alone, the intensity of the incident light must be increased. Thus, when the subcell 30b is made capable of displaying red as well, as the aperture ratio for red increases the intensity of the incident light need not be increased. Thus, by setting one surface plasmon resonance peak of the optical filter 1b at 500 to 560 nm, and another peak at 610 to 750 nm, green and red can be displayed on the subcell 30b.

To produce black, light need only be absorbed by the light intensity adjusters 6a, 6b. To produce white, the metallic particles 42a, 42b need only be made to scatter the three colors red, green, and blue. In this embodiment, the light intensity adjusters 6a, 6b are disposed between the polarizing plate 2 and the directional adjusters 3a, 3b, but they may also be disposed on the light incident side of the polarizing plate 2 (on the viewer side).

In this embodiment, as in the fourth and fifth embodiments, it is possible to display full color using two optical filters 1a, 1b, and because the unlit field can be reduced from 66% to 50% and the aperture ratio increased compared to when a conventional color filter is used, light use efficiency can be improved.

In the embodiments described above, an optical filter was used adjusting the incident light polarization to adjust the direction of the anisotropicity with respect to the metallic particles 42a, 42b, but a similar optical filter can be manufactured even when the metallic particles 42a, 42b are rotated. When it is possible to rotate the metallic particles 42a, 42b in three dimensions, one optical filter can have three surface plasmon resonance wavelengths, thus allowing for full color display using one optical filter, further improving light use efficiency.

As described in the above embodiments, the display according to the present invention uses the optical filter according to the present invention, and is thus capable of adjusting the relative angles of the anisotropicity of the metallic particles and the polarization of the light source, and of displaying two colors and a mixture thereof. As a result, the number of optical filters needed to display full color can be made two or less, allowing for the unlit field to be reduced, allowing for a high aperture ratio and preventing reductions in light use efficiency.

Because the surface plasmon resonance wavelength shifts when a polarization between the long axis and the short axis enters the filter along with the two colors corresponding to the long axis and the short axis, it is possible to display full color using three resonance wavelengths, allowing for full color to be displayed using one optical filter. It is thereby possible to eliminate the unlit field, allowing light use efficiency to be further improved.

### Seventh Embodiment

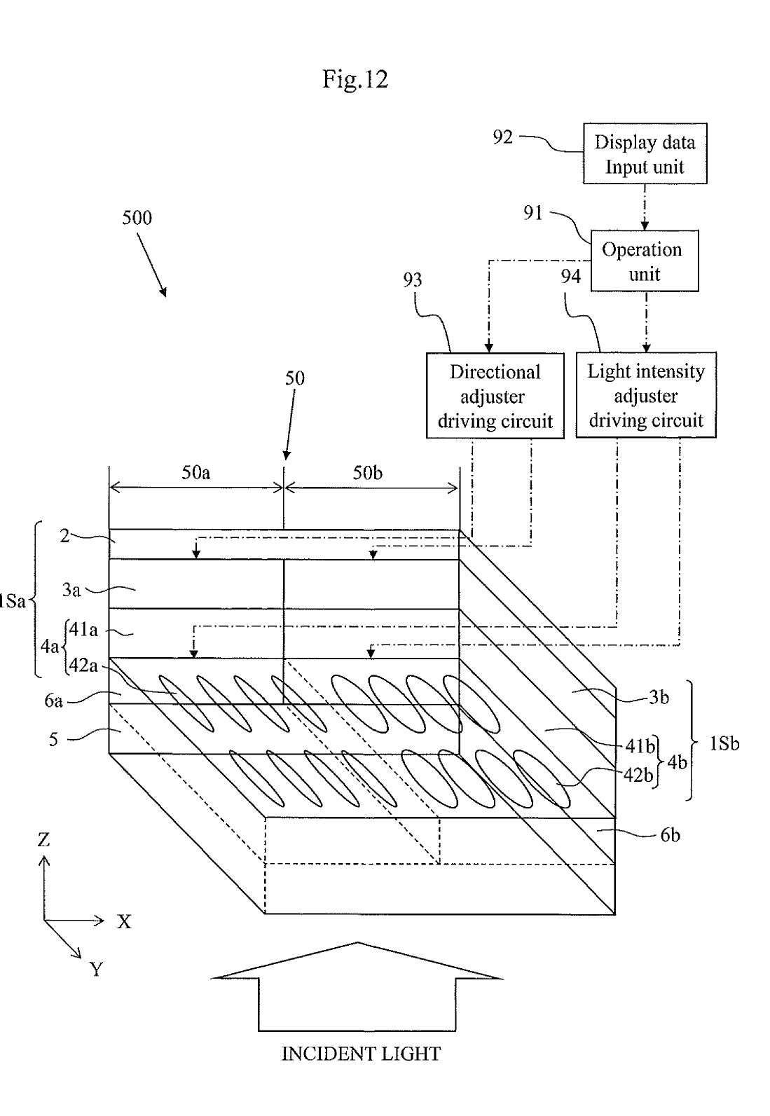

Next, a display according to the present invention will be described with reference to the drawings. FIG. 12 is an outline of the configuration of one example of a display according to the present invention. For the sake of ease in description, the display 500 shown in FIG. 12 has one display cell 50 in its configuration, but, in actuality, a plurality of display cells 50 are arrayed in a vertical and horizontal matrix (for example, 1,080 units vertically by 1,920 units horizontally). The display cell 50 will be primarily described in the following description. This embodiment uses the first optical filter 1S, but is not limited to this, and may also use the second optical filter 1T. There are parts that have essentially the same configuration as the display shown in FIG. 9; the same parts will have the same labels, and detailed description thereof will be omitted.

The display 500 is a transmission display, and is viewed by a viewer from the first optical filters 1Sa, 1Sb side (polarizing plate 2 side). As shown in FIG. 12, the display 500 has the display cell 50, an operation unit 91, a display data input unit 92, a direction adjuster driving circuit 93, and light intensity adjuster driving circuit 94.

The display cell 50 is divided into subcells 50a, 50b aligned in the X direction, and has the first optical filters 1Sa, 1Sb, a light source 5, and light intensity adjusters 6a, 6b. The optical filters 1Sa, 1Sb are disposed aligned in the X direction. The subcell 50a and the subcell 50b are each capable of different displays (displaying different colors).

The light source 5 need only emit visible light. When performing full color display, a light source 5 emitting white light is preferred. Examples of light source 5 include a fluorescent light, an incandescent bulb, an LED, a laser light source, or the like. A diffuser panel or a light-guiding panel that irradiates the light from the light source 5 over a complete surface may be provided. When the light source 5 is one that outputs linearly polarized light such as, for example, a laser light source, the laser light source can be made to correspond to full color display by setting the light source so that the polarization thereof is parallel with neither the long axis nor the short axis of the metallic particles. It is also possible to correspond to full color display by disposing a quarter-wave plate or the like between the light source 5 and the optical filters 1Sa, 1Sb, so that circularly polarized light incident on the filter units 4a, 4b.

The light intensity adjusters 6a, 6b adjust the intensity of the light irradiating the metallic particles 42a, 42b (in other words, the transmission of the light). The light intensity adjuster 6a and 6b integrate the optical filters 1Sa, 1Sb so that a desired color is seen, and when the incident light is linearly polarized light, a combination of a polarizing plate and a liquid crystal element can be used. That is, one need only to rotate the polarization using the liquid crystal element of the light intensity adjusters 6a, 6b, and directs the light onto the polarizing plate of the light intensity adjuster 6a and 6b. The light transmitted by the light intensity adjusters 6a, 6b has a fixed polarization, and the light intensity adjusters 6a, 6b are disposed so that the polarization of the transmitted light forms a predetermined angle with the long axis and the short axis of the metallic particles 42a, 42b of the filter units 4a, 4b.

When the incident light is randomly or circularly polarized, an electrochromatic material, of which color changes when an electric charge is applied thereto, can be used for the light intensity adjusters 6a, 6b. By applying a voltage to the light intensity adjusters 6a, 6b for which an electrochromic material was used, it is possible to change the intensity (transmission) of the transmitted light. In this embodiment, the light intensity adjusters 6a, 6b are disposed between the light source 5 and the filter units 4a, 4b, and be disposed anywhere after the light source 5.

The optical filter 1Sa has a polarizing plate 2, directional adjuster 3a, and filter unit 4a. Likewise, the optical filter 1Sb has a polarizing plate 2, a directional adjuster 3b, and a filter unit 4b. The polarizing plate 2 is a member shared by the optical filters 1Sa, 1Sb. In the following description, the directional adjusters 3a, 3b are liquid crystal elements adjusting the incident light polarization, but are not limited to this as long as they relatively change the incident light polarization and the anisotropic orientation of metallic particles 42a, 42b.

In the optical filter 1Sa and 1Sb, the polarizing plate 2, direction adjusting means 3a, 3b, and filter units 4a, 4b (transparent dielectric media 41Sa, 41Sb and metallic particles 42a, 42b) are as in the optical filter 1S described above, but the metallic particles 42a, 42b have different shapes in the optical filter 1Sa and the optical filter 1Sb. For example, when the subcell 50a displays colors from red to blue and the subcell 50b displays green, three primary colors, i.e., full color, can be produced by the display cell 50.

Because the human eye has low sensitivity to red, when red is displayed by the subcell 50a alone, the intensity of the incident light must be increased. When the subcell 50a and the subcell 50b are both made capable of displaying red, as the aperture ratio for red increases, the intensity of the incident light need not be increased. Due to the foregoing considerations, in the display cell 50, the subcell 50a displays red and blue, and the subcell 50b displays red and green. The optical filter 1Sa produces both red and blue, and the optical filter 1Sb produces both red and green.

In the display cell 50 shown in FIG. 12, the subcell 50a displays red and blue, and thus has metallic particles 42a so that the filter unit 4a has absorption peaks in the two wavelength regions of 490 to 500 nm and 580 to 595 nm. The subcell 50b displays green and red, and thus has metallic particles 42b so that the filter unit 4b has absorption peaks in the two wavelength regions of 750 to 800 nm and 490 to 500 nm.

The direction adjuster driving circuit 93 sends an electronic signal to the directional adjusters 3a, 3b on the basis of the data received from the operation unit 91, and selects a desired polarization out of the light transmitted by the filter units 4a, 4b. In the case of a configuration having an individual light source 5 for each of the subcells 50a, 50b, a configuration in which the light intensity adjuster driving circuit 94 sends an electronic signal to the light source 5 and adjusts the luminescent intensity is possible. In this case, the light intensity adjusters 6a, 6b may be omitted, and the light transmission of the subcells 50a, 50b can be increased.

In order to display the image or video data received from the display data input unit 92 on the display cell 50, the operation unit 91 includes a processing circuit for calculating the intensity of incident light and the polarization of transmitted light for each of the cells and outputting the results to the light intensity adjusters 6a, 6b and the directional adjusters 3a, 3b.

Next, the operation of the display 500 will be described. First, the image/video data is inputted to the display data input unit 92. The operation unit 91 decides the color and intensity for each of the display cells 50 on the basis of the image/video data, and calculates the intensity of the incident light and the polarization of transmitted light selected from the filter units 4a, 4b based on the color information. The operation unit 91 sends a signal containing transmitted light polarization information to the direction adjuster driving circuit 93, and a signal containing intensity information to the light intensity adjuster driving circuit 94.

The direction adjuster driving circuit 93 sends a drive signal to the directional adjusters 3a, 3b on the basis of the signal received from the operation unit 91. The light intensity adjuster driving circuit 94 sends a drive signal to the light intensity adjusters 6a, 6b on the basis of the signal received from the operation unit 91. The drive signal sent to the directional adjusters 3a, 3b is an independent signal, and applies a voltage for driving the liquid crystal element to the electrode substrate. Likewise, the drive signal sent to the light intensity adjusters 6a, 6b is an independent signal, and applies a voltage for driving the liquid crystal element to the electrode substrate.

By receiving the drive signal from the light intensity adjuster driving circuit 94, the light intensity adjuster 6a and 6b adjust the transmission of the light from the light source 5, and adjusts the intensity of the light incident on the directional adjusters 3a, 3b. After having the intensity thereof adjusted by the light intensity adjusters 6a, 6b, the incident light enters the filter units 4a, 4b. On the other hand, by receiving the drive signal from the direction adjuster driving circuit, the directional adjusters 3a, 3b rotationally adjusts the polarization of the light transmitted by the filter units 4a, 4b. The light of the wavelength region determined by the anisotropicity of the metallic particles 42a, 42b and the polarization of transmitted light extracted by the polarizing plate 2 is absorbed in the filter units 4a, 4b. A desired color is thereby displayed by the subcells 50a, 50b; i.e., by the display cell 50.

Hereafter follows a description of red, green, blue, intermediate colors thereof, white, and black each being displayed by a display cell 50 according to the present invention.

Hereafter follows a description of red being displayed. The direction adjuster driving circuit 93 controls the directional adjusters 3a, 3b so as to adjust the polarization of the light transmitted by the filter units 4a, 4b so that red is displayed. The light intensity adjuster driving circuit 94 controls the light intensity adjusters 6a, 6b, and sets the intensity of the light incident on the directional adjusters 3a, 3b to an optimal intensity. By controlling each part of the display cell 50 in this way, red is displayed by the subcells 50a, 50b. The display cell 50 thereby displays red (displays red in the far field).

Hereafter follows a description of green being displayed. The direction adjuster driving circuit 93 controls the directional adjuster 3b so as to adjust the polarization of the light transmitted by the filter unit 4b so that green is displayed. The light intensity adjuster driving circuit 94 controls the light intensity adjuster 6b, and sets the intensity of the light incident on the directional adjuster 3b to an optimal intensity. The light intensity adjuster driving circuit 94 controls the light intensity adjuster 6a, and blocks the filter unit 4a from the incident light (sets the incident light intensity to zero). By controlling each part of the display cell 50 in this way, the subcell 50a displays nothing (i.e., displays black), and the subcell 50b displays green. The display cell 50 thereby displays green (displays green in the far field).

Hereafter follows a description of blue being displayed. The direction adjuster driving circuit 93 controls the directional adjuster 3a so as to adjust the polarization of the light transmitted by the filter unit 4a so that blue is displayed. The light intensity adjuster driving circuit 94 controls the light intensity adjuster 6a, and sets the intensity of the light incident on the directional adjuster 3a to an optimal intensity. The light intensity adjuster driving circuit 94 controls the light intensity adjuster 6b, and blocks the filter unit 4b from the incident light (sets the incident light intensity to zero). By controlling each part of the display cell 50 in this way, the subcell 50a displays blue, and the subcell 50b displays nothing (i.e., displays black). The display cell 50 thereby displays blue (displays blue in the far field).

By suitably adjusting the relative intensities of red, blue, and green, intermediate colors can be displayed. By setting the subcell 50a to display red and blue, and the subcell 50b to display green and red, the display cell 50 displays white.

When displaying black, the light intensity adjuster driving circuit 94 need only adjust the light intensity adjusters 6a, 6b so that no light enters the filter units 4a, 4b.

As described above, the display 500 uses the optical filters 1Sa, 1Sb according to the present invention, and is capable of displaying two colors and a mixture thereof on one subcell by adjusting the relative angles of the anisotropicity of the metallic particles 42a, 42b and the polarization of the transmitted light. It is thereby possible to reduce the number of filters needed to display full color to two or less.

In a conventional color filter with separate RGB coated sections, a display cell has a red (R) display subcell, a green (G) display subcell, and a blue (B) display subcell. When, for example, red (R) is displayed, the green (G) display subcell and the blue (B) display subcell are darkened, and two pixels are unlit. In other words, when red (R), green (G), and blue (B), are displayed, a 66% unlit field is generated in a conventional display cell.

In the display cell 50 according to the present invention, as described above, color can tuned by controlling the polarization, so that subcells 50a, 50b are lit when red is displayed, generating no unlit field. When green is displayed, the subcell 50a is unlit, and when blue is displayed, the subcell 50b is unlit, shrinking the unlit field from 66% to 50% and increasing light use efficiency, allowing for brighter display, or for reduced energy consumption for the same display.

Along with the two resonance wavelengths corresponding to the long axis and the short axis, the optical filter of the present invention can apply a polarization between the long axis and the short axis and shift the surface plasmon resonance peak to add a third resonance wavelength. By using such an optical filter, it is possible to produce all of RGB (light of wavelengths corresponding to RGB) in full color as necessary with one optical filter, and the display cell can display full color using one optical filter, i.e., one subcell. In this case, the unlit field disappears, enabling for further light use efficiency improvement. The direction adjuster driving circuit 93 and light intensity adjuster driving circuit 94 can also be simplified.

The filter units 4a, 4b are not limited to those described above, and may be of the configuration described for the fourth embodiment,

Above were described cases in which a first optical filter 1S was used as the display 500 and the filter units 4a, 4b each displayed two colors and a mixture thereof, displaying each of red, green, blue, intermediate colors thereof, white, and black on the display cell 50 (subcells 50a, 50b), but the invention is not limited to this.

For example, by adjusting the polarization of light transmitted by the filter units 4a, 4b, the filter units 4a, 4b are capable of producing three colors, four colors, and mixtures thereof. By using a first optical filter 1S and/or a second optical filter 1T with filter units 4a, 4b having such a configuration, the colors capable of being produced by combination increase, improving the color reproduction ability of the display 500.

Because the second optical filter 1T has the effect of increasing contrast as described above, it is possible to use a second optical filter 1T for the display to obtain a display 500 with high color reproduction and high contrast.

A configuration in which the display cell 50 has three subcells is also possible. In a normal RGB 3-pixels configuration, a triangular range within a chromaticity diagram surrounded by three RGB peak wavelength points is the color production field, but it is possible to use an optical filter to obtain points for wavelengths other than R, G, and B, allowing the shape of the reproduction field triangle on the chromaticity diagram to be changed. In other words, the color production range can be broadened.

Embodiments of the present invention were described above, but the present invention is not limited to these. Various modifications within the scope of the invention may be made to the embodiments of the present invention.

The optical filter according to the present invention can be used as a color filter for a display performing full color display.

What is claimed is:

1. An optical filter comprising:
a filter unit in which a plurality of metallic particles having two or more anisotropic axes are disposed with uniform orientations on a surface or interior part of a transparent dielectric medium transmitting visible light; and
direction adjusting means for changing, in a relative manner, the polarization of incident light, which incident on the filter unit with linear polarization, and the orientation of the anisotropic axes of the metallic particles.

2. An optical filter comprising:
a filter unit in which a plurality of metallic particles having two or more anisotropic axes are disposed with uniform orientations on a surface or interior part of a transparent dielectric medium transmitting visible light; and
direction adjusting means for changing, in a relative manner, the polarization of transmitted light transmitted through the filter unit and the orientation of the anisotropic axes of the metallic particles.

3. The optical filter according to claim 1, wherein:
the direction adjusting means rotates the incident light polarization in parallel or perpendicularly to the anisotropic axes of the metallic particles.

4. The optical filter according to claim 2, wherein:
the direction adjusting means rotates the polarization of the transmitted light in parallel or perpendicularly to the anisotropic axes of the metallic particles.

5. The optical filter according to claim 1, wherein:
the transparent dielectric medium rotatably supports the plurality of metallic particles; and
the direction adjusting means rotates the plurality of metallic particles in an orientation-aligned state either on the surface or in the interior of the transparent dielectric medium.

6. The optical filter according to claim 2, wherein:
the transparent dielectric medium rotatably supports the plurality of metallic particles; and
the direction adjusting means rotates the plurality of metallic particles in an orientation-aligned state on either the surface or in the interior of the transparent dielectric medium.

7. The optical filter according to claim 5, wherein:
the plurality of metallic particles have three anisotropic axes; and
the direction adjusting means rotates the plurality of metallic particles either on the surface or in the interior of the transparent dielectric medium in a direction perpendicular to the surface of the transparent dielectric medium.

8. The optical filter according to claim 6, wherein:
the plurality of metallic particles have three anisotropic axes; and
the direction adjusting means rotates the plurality of metallic particles either on the surface or in the interior of the transparent dielectric medium in a direction perpendicular to the surface of the transparent dielectric medium.

9. The optical filter according to claim 2, wherein:
incident light whose polarization is neither parallel nor perpendicular to either of the two anisotropic axes of the metallic particles enters the filter unit.

10. The optical filter according to claim 6, further comprising:
second direction adjusting means for changing, in a relative manner, the polarization of light incident on the filter unit and the orientation of the anisotropic axes of the metallic particles.

11. The optical filter according to claim 10, wherein:
the transparent dielectric medium rotatably supports the plurality of metallic particles; and
either one of the direction adjusting means and the second direction adjusting means rotates the plurality of metallic particles in an orientation-aligned state either on the surface or in the interior of the transparent dielectric medium.

12. The optical filter according to claim 11, wherein:
the plurality of metallic particles have three anisotropic axes; and
either one of the direction adjusting means and the second direction adjusting means also rotates the plurality of metallic particles either on the surface or in the interior of the transparent dielectric medium in a direction perpendicular to the surface of the transparent dielectric medium.

13. The optical filter according to claim 1, wherein:
the plurality of metallic particles is also arrayed in the light irradiation direction, and the array spacing in the light irradiation direction is five or more times the light irradiation direction length of the metallic particles.

14. The optical filter according to claim 2, wherein:
the plurality of metallic particles is also arrayed in the light irradiation direction, and the array spacing in the light irradiation direction is five or more times the light irradiation direction length of the metallic particles.

15. A display cell comprising:
the optical filter according to claim 1;
a light source for emitting visible light; and
a light intensity adjuster for adjusting the intensity of light entering the optical filter:

16. A display cell comprising:
the optical filter according to claim 2;
a light source for emitting visible light; and
a light intensity adjuster for adjusting the intensity of light entering the optical filter:

17. The display cell according to claim 15,
comprising two optical filters; wherein
both of the two optical filters have a filter unit where the surface plasmon resonance
wavelength of the metallic particles is a complementary color of red.

18. The display cell according to claim 16,
comprising two optical filters; wherein
both of the two optical filters have a filter unit where the surface plasmon resonance wavelength of the metallic particles is a complementary color of red.

19. The display cell according to claim 15,
comprising two optical filters; wherein
one of the two optical filters has a filter unit where the surface plasmon resonance wavelengths of the metallic particles are complementary colors of red and blue, and the other optical filter has a filter unit where the surface plasmon resonance wavelengths of the metallic particles are complementary colors of green and yellow.

20. The display cell according to claim 16,
comprising two optical filters; wherein
one of the two optical filters has a filter unit where the surface plasmon resonance wavelengths of the metallic particles are complementary colors of red and blue, and the other optical filter has a filter unit where the surface plasmon resonance wavelengths of the metallic particles are complementary colors of green and yellow.

21. A display cell comprising:
the optical filter according to claim 1;
an anti-reflective layer for reducing visible light reflectivity; and
a light intensity adjuster for adjusting the intensity of light entering the optical filter.

22. The display cell according to claim 21,
comprising two optical filters; wherein
both of the two optical filters have a filter unit in which the surface plasmon resonance wavelength of the metallic particles is red.

23. A display cell comprising:
the optical filter according to claim 1;
a scattering layer for scattering visible light; and
a light intensity adjuster for adjusting the intensity of light entering the scattering layer.

24. A display cell comprising:
the optical filter according to claim 2;
a scattering layer for scattering visible light; and
a light intensity adjuster for adjusting the intensity of light entering the scattering layer.

25. The display cell according to claim 23,
comprising two optical filters; wherein
one of the two optical filters has a filter unit in which the surface plasmon resonance wavelength of the metallic particles is outside the visible spectrum.

26. The display cell according to claim 24,
comprising two optical filters; wherein
one of the two optical filters has a filter unit in which the surface plasmon resonance wavelength of the metallic particles is outside the visible spectrum.

27. A display comprising:
a plurality of display cells according to claim 15; wherein:
the plurality of display cells are arrayed in one or two dimensions.

28. A display comprising:
a plurality of display cells according to claim 16; wherein:
the plurality of display cells are arrayed in one or two dimensions.

29. A display comprising:
a plurality of display cells according to claim 21; wherein:
the plurality of display cells are arrayed in one or two dimensions.

30. A display comprising:
a plurality of display cells according to claim 23; wherein:
the plurality of display cells are arrayed in one or two dimensions.

31. A display comprising:
a plurality of display cells according to claim 24; wherein:
the plurality of display cells are arrayed in one or two dimensions.

32. The display according to claim 27, further comprising:
a data input unit into which image data is inputted;
a direction adjuster driving circuit for controlling the direction adjusting means;
a light intensity adjuster driving circuit for controlling the light intensity adjuster; and
a operation unit for deciding the color and intensity displayed by each of the display cells on the basis of the image data, and issuing an instruction to the direction adjuster driving circuit and the light intensity adjuster driving circuit so as to drive the direction adjusting means and the light intensity adjuster of each of the display cells based on the color and intensity.

33. The display according to claim 28, further comprising:
a data input unit into which image data is inputted;
a direction adjuster driving circuit for controlling the direction adjusting means;
a light intensity adjuster driving circuit for controlling the light intensity adjuster; and
a operation unit for deciding the color and intensity displayed by each of the display cells on the basis of the image data, and issuing an instruction to the direction adjuster driving circuit and the light intensity adjuster driving circuit so as to drive the direction adjusting means and the light intensity adjuster of each of the display cells based on the color and intensity.

34. The display according to claim 29, further comprising:
a data input unit into which image data is inputted:
a direction adjuster driving circuit for controlling the direction adjusting means;
a light intensity adjuster driving circuit for controlling the light intensity adjuster; and
a operation unit for deciding the color and intensity displayed by each of the display cells on the basis of the image data, and issuing an instruction to the direction adjuster driving circuit and the light intensity adjuster driving circuit so as to drive the direction adjusting means and the light intensity adjuster of each of the display cells based on the color and intensity.

35. The display according to claim 30, further comprising:
a data input unit into which image data is inputted;
a direction adjuster driving circuit for controlling the direction adjusting means;
a light intensity adjuster driving circuit for controlling the light intensity adjuster; and
a operation unit for deciding the color and intensity displayed by each of the display cells on the basis of the image data, and issuing an instruction to the direction adjuster driving circuit and the light intensity adjuster driving circuit so as to drive the direction adjusting means and the light intensity adjuster of each of the display cells based on the color and intensity.

36. The display according to claim 31, further comprising:
a data input unit into which image data is inputted;
a direction adjuster driving circuit for controlling the direction adjusting means;
a light intensity adjuster driving circuit for controlling the light intensity adjuster; and
an operation unit for deciding the color and intensity displayed by each of the display cells on the basis of the image data, and issuing an instruction to the direction adjuster driving circuit and the light intensity adjuster driving circuit so as to drive the direction adjusting means and the light intensity adjuster of each of the display cells based on the color and intensity.
